(19) United States
(12) Patent Application Publication
(10) Pub. No.: US 2025/0031076 A1
(43) Pub. Date: Jan. 23, 2025

(54) METHOD FOR CELL MEASUREMENT, AND DEVICE

(71) Applicant: GUANGDONG OPPO MOBILE TELECOMMUNICATIONS CORP., LTD., Dongguan (CN)

(72) Inventors: Jiangsheng FAN, Dongguan (CN); Xin YOU, Dongguan (CN); Xue LIN, Dongguan (CN); Haitao LI, Dongguan (CN)

(21) Appl. No.: 18/910,716

(22) Filed: Oct. 9, 2024

Related U.S. Application Data
(63) Continuation of application No. PCT/CN2022/086677, filed on Apr. 13, 2022.

(51) Int. Cl. H04W 24/08

(52) U.S. Cl. CPC H04W 24/08

(57) ABSTRACT

Provided is a method for cell measurement, and a device. The method is applicable to a terminal device. The method includes: performing neighbor cell layer 1 (L1) measurement based on an L1 measurement configuration. The device includes a processor, wherein the processor, when loading and running a computer program, is caused to perform the method for cell measurement.

### CROSS-REFERENCE TO RELATED APPLICATION

This application is a continuation application of international application No. PCT/CN2022/086677, filed on Apr. 13, 2022, the entire contents of which are incorporated herein by reference.

### TECHNICAL FIELD

Embodiments of the present disclosure relate to the technical field of communications, and in particular, relate to a method and apparatus for cell measurement, and a device and a storage medium.

### RELATED ART

To manage and control the mobility of terminal devices between cells, the network device typically configures layer 3 (L3) measurement configuration for the terminal devices. Based on the L3 measurement configuration defined by the network device, the terminal devices perform neighbor cell measurements. Exemplarily, L3 refers to radio resource control (RRC).

### SUMMARY

Embodiments of the present disclosure provide a method and apparatus for cell measurement, a device, and a storage medium. The technical solutions are as follows:

According to some embodiments of the present disclosure, a method for cell measurement is provided. The method is applicable to a terminal device and includes:
performing neighbor cell layer 1 (L1) measurement based on an L1 measurement configuration.

According to some embodiments of the present disclosure, a terminal device is provided. The terminal device includes a processor; wherein the processor, when loading and running at least one computer program, is caused to perform the method for cell measurement as described above.

According to some embodiments of the present disclosure, a network device is provided. The network device includes a processor; wherein the processor, when loading and running at least one computer program, is caused to: transmit an L1 measurement configuration to a terminal device, wherein the L1 measurement configuration is defined for the terminal device to perform neighbor cell L1 measurement.

### BRIEF DESCRIPTION OF THE DRAWINGS

For clearer description of the technical solutions according to the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of a mobile communication system according to some exemplary embodiments of the present disclosure;

FIG. 2 is a flowchart of a method for cell measurement according to some exemplary embodiments of the present disclosure;

FIG. 3 is a flowchart of a method for cell measurement according to some other exemplary embodiments of the present disclosure;

FIG. 4 is a flowchart of a method for cell measurement according to some other exemplary embodiments of the present disclosure;

FIG. 5 is a flowchart of a method for cell measurement according to some other exemplary embodiments of the present disclosure;

FIG. 6 is a flowchart of a method for cell measurement according to some other exemplary embodiments of the present disclosure;

FIG. 7 is a flowchart of a method for cell measurement according to some other exemplary embodiments of the present disclosure;

FIG. 8 is a flowchart of a method for cell measurement according to some other exemplary embodiments of the present disclosure;

FIG. 9 is a flowchart of a method for cell measurement according to some other exemplary embodiments of the present disclosure;

FIG. 10 is a flowchart of a method for cell measurement according to some other exemplary embodiments of the present disclosure;

FIG. 11 is a flowchart of a method for cell measurement according to some other exemplary embodiments of the present disclosure;

FIG. 12 is a structural block diagram of an apparatus for cell measurement according to some exemplary embodiments of the present disclosure;

FIG. 13 is a structural block diagram of an apparatus for cell measurement according to some other exemplary embodiments of the present disclosure; and

FIG. 14 is a schematic structural diagram of a communication device according to some exemplary embodiments of the present disclosure.

### DETAILED DESCRIPTION

For clearer descriptions of the objectives, technical solutions, and advantages of the present disclosure, embodiments of the present disclosure are further described in detail below with reference to the accompanying drawings.

First, some relevant knowledge related to the present disclosure will be introduced:
L3 Measurement: To manage and control the mobility of terminal devices between cells, the network device typically configures L3 measurement-related configuration for the terminal devices. Based on the L3 measurement-related configuration defined by the network device, the terminal devices perform neighbor cell measurements.

In the case of performing an L3 measurement on a neighbor cell, it is necessary to know both the frequency point and the physical cell identity (PCI) information of the cell. The network device transmits the frequency point information to the terminal device over dedicated signaling or system broadcast messages. Optionally, the network device further provides one or more pieces of PCI information associated with a to-be-measured frequency point to the terminal device, thereby assisting the terminal device in performing the measurement more quickly. However, the PCI information is an optional configuration.

In the case that the network device only configures the frequency point information for the terminal device, then the terminal device needs to identify all cells possibly measured under that frequency point through implementation methods. In the new radio (NR) system, there are a total of 1008 types of PCI. Theoretically, for a to-be-measured frequency point, the terminal device may need to attempt up to 1008 times to measure and identify all cells under that frequency point.

For a terminal device in a connected state, the network device transmits the L3 measurement-related configuration to the terminal device over dedicated signaling. The L3 measurement-related configuration transmitted over the dedicated signaling includes at least the following parts:

(1) At least one measurement object (MO) that needs to be added or modified, and/or at least one MO that needs to be deleted.

One MO typically includes an identifier of a to-be-measured frequency point and the SMTC (synchronization signal/physical broadcast channel (SS/PBCH) block measurement time configuration) configuration associated with the measurement reference signal corresponding to the to-be-measured frequency point. The identifier of the to-be-measured frequency point is used to inform the terminal device of the to-be-measured frequency point corresponding to the MO. The measurement reference signal corresponding to the to-be-measured frequency point may be an SSB (synchronization signal/physical broadcast channel block) (also abbreviated as SS/PBCH block) or a channel state information reference signal (CSI-RS). The SMTC associated with the measurement reference signal is used to inform the terminal device of the time-domain position where the measurement reference signal occurs, i.e., the measurement window information. Typically, the measurement reference signal occurs periodically, and thus the SMTC window also occurs periodically. The SMTC usually includes the measurement period, measurement offset, and measurement length configuration.

(2) At least one measurement reporting configuration that needs to be added or modified, and/or at least one measurement reporting configuration that needs to be deleted.

Based on the MO configured by the network device, the terminal device is capable of acquiring the measurement result of the neighbor cell L3 measurement. However, the terminal device still does not know when to report the measurement result and the format of the reported measurement result. Therefore, in addition to the MO configuration, the network device will also configure the measurement reporting configuration to control the measurement reporting behavior of the terminal device. Typically, the measurement reporting configuration includes information such as the measurement reference signal, measurement event, and measurement quantity. Specifically, the measurement reference signal may be an SSB or a CSI-RS; the measurement event may be a periodically triggered measurement event or an event-triggered measurement event; and the measurement quantity may be at least one of reference signal received power (RSRP), reference signal received quality (RSRQ), or signal to interference plus noise ratio (SINR).

(3) At least one measurement ID that needs to be added or modified, and/or at least one measurement ID that needs to be deleted.

One measurement ID is associated with one MO and one measurement reporting configuration, thereby achieving a many-to-many mapping relationship between multiple MOs and multiple measurement reporting configurations. Measurement reporting is conducted in units of the measurement ID, that is, a single measurement report includes the measurement result corresponding to one measurement ID.

Layer 1 (L1) Measurement: In the context of high frequencies, cells typically use a multi-beam method for communication. As the terminal device moves within the cell, the optimal service beam for the terminal device may change. To enable the network device to promptly adjust the service beam for the terminal device, the related art has introduced beam management content. Because beam management for a terminal device in an idle or inactive state is implemented by the terminal device, the beam management content in the related art is only targeted at a terminal device in a connected state. Exemplarily, L1 refers to the physical layer.

Serving Cell: A serving cell includes at least the primary cell (PCell), and at the same time optionally includes at least one of the secondary cell (SCell) and the primary secondary cell (PSCell). The serving cell refers to the cell that establishes a radio resource control (RRC) connection with the terminal device and provides service to the terminal device.

Neighbor Cell (NCell): A neighbor cell is also referred to as a neighboring cell (or adjacent cell, or the like), and it refers to cells other than the current serving cell that the terminal device is accessing.

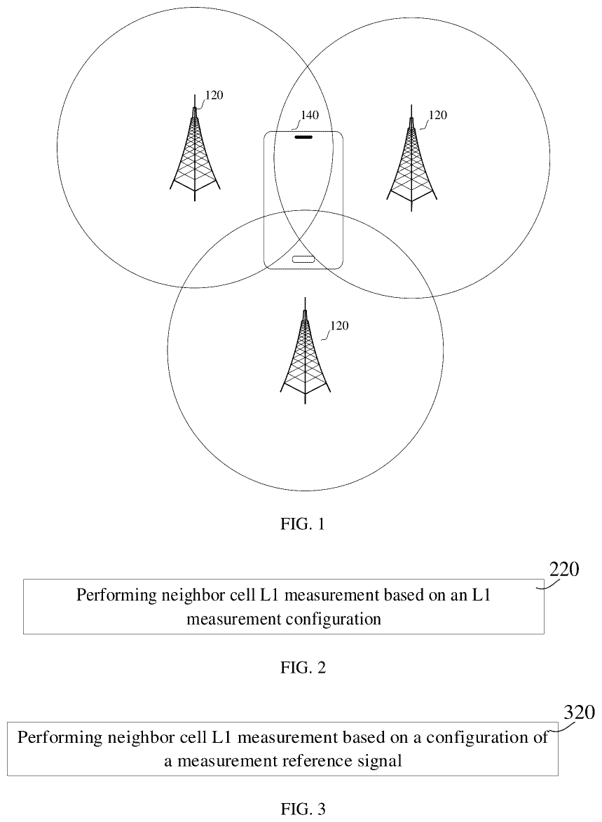

FIG. 1 illustrates a schematic structural diagram of a mobile communication system according to some embodiments of the present disclosure. The mobile communication system may be an LTE system or the 5^{th} generation (5G) mobile communication technology, which is also referred to as the NR system. The mobile communication system includes network devices 120 and a terminal device 140.

The network device 120 may be a base station. The base station may be configured to convert a received wireless frame into IP packet messages and vice versa, and it may also coordinate the attribute management for the air interface. For example, the base station may be an evolutional node B (eNB or e-NodeB) in LTE, or a base station using a centralized distributed architecture in a 5G system.

In some embodiments, in the mobile communication system shown in FIG. 1, different network devices 120 correspond to their respective wireless signal coverage areas (circular areas with the network devices 120 at the center). These wireless signal coverage areas are referred to as cells, and there are intersections between different cells. In other possible embodiments, the same network device 120 may correspond to multiple cells, and each cell corresponds to a different identifier, which is not limited in the embodiments of the present disclosure.

The network device 120 and the terminal device 140 establish a wireless connection over a radio air interface. In some embodiments, the radio air interface is based on the long-term evolution (LTE) standard; or, the radio air interface is based on the 5G standard, and for example, the radio air interface is an NR; or, the radio air interface may also be based on the next-generation mobile communication network technology standard beyond 5G.

The terminal device 140 may refer to a device that provides voice and/or data connectivity to a user. The terminal device may communicate with one or more core networks over a radio access network (RAN). The terminal device 140 may be a mobile terminal device, such as a mobile phone (also referred to as a “cellular” phone) and a computer with a mobile terminal device, for example, it may be a portable, pocket-sized, handheld, computer-integrated, or vehicle-mounted mobile apparatus. Examples include subscriber unit, subscriber station, mobile station, mobile, remote station, access point, remote terminal, access terminal, user terminal, user agent, user device, or user equipment.

The method for cell measurement according to the various embodiments of the present disclosure is applicable to the scenario where the terminal device 140 performs signal measurement on a neighbor cell in RRC idle state, RRC inactive state, or RRC connected state.

In the related art, the L3 measurement mechanism has a slow processing speed (due to the L3 filtering process, which requires averaging multiple sampling results) and requires the RRC process to trigger handovers. In the case that the L3 measurement mechanism is used to measure high-frequency cells, the frequent RRC handovers result in high signaling overhead. The L3 measurement mechanism is not conducive to achieving rapid handovers in the context of frequent handovers.

The following will elaborate on various embodiments.

FIG. 2 illustrates a flowchart of a method for cell measurement according to some exemplary embodiments of the present disclosure. Description is given based on an example in which the method is applicable to a terminal device. The method includes the following processes.

In process 220, neighbor cell L1 measurement is performed based on an L1 measurement configuration.

In some embodiments, the terminal device performs the neighbor cell L1 measurement based on a configuration of a measurement reference signal, wherein the configuration of the measurement reference signal is defined to perform neighbor cell L1 measurement.

Alternatively, the terminal device performs the neighbor cell L1 measurement based on the configuration of the measurement reference signal for performing the neighbor cell L1 measurement and the measurement gap configuration for performing the neighbor cell L1 measurement.

Alternatively, the terminal device performs the neighbor cell L1 measurement based on the configuration of the measurement reference signal for performing the neighbor cell L1 measurement, the measurement gap configuration for performing the neighbor cell L1 measurement, and the L1 measurement gap sharing configuration for performing the neighbor cell L1 measurement.

In some embodiments, the L1 measurement configuration for performing the neighbor cell L1 measurement is configured through any one of the following messages:
an RRC message;
a system broadcast message;
a medium access control (MAC) control element (CE) message; or
a downlink control information (DCI) message.

In some embodiments, the L1 measurement configuration for performing neighbor cell L1 measurement may also be subject to configuration addition, configuration update, configuration deletion, or configuration deactivation operations through any one of the following messages:
an RRC message;
a system broadcast message;
a MAC CE message; or
a DCI message.

It should be noted that in process 220, “performing neighbor cell L1 measurement” may be replaced with “performing serving cell L1 measurement”. In this case, “serving cell L1 measurement” includes both serving cell L1 measurement and neighbor cell L1 measurement. This is because, in the case of executing the L1 measurement task, the network device transmits the serving cell L1 measurement-related configuration and the neighbor cell L1 measurement-related configuration to the terminal device, and the terminal device may not distinguish between measurements for the serving cell and the neighbor cell. Exemplarily, the network device transmits the L1 measurement-related configurations for the serving cell with frequency point 1 and PCI 1, the neighbor cell with frequency point 1 and PCI 2, and the neighbor cell with frequency point 1 and PCI 3 to the terminal device, and the terminal device performs L1 measurements on the cells above. Under one definition rule, serving cell L1 measurement only includes the L1 measurement for the cell corresponding to frequency point 1 and PCI 1, while L1 measurements for the cell corresponding to frequency point 1 and PCI 2 and the cell corresponding to frequency point 1 and PCI 3 are referred to as neighbor cell L1 measurements. Under another definition rule, the L1 measurement for the cell corresponding to frequency point 1 and PCI 1 as well as the L1 measurements for the cell corresponding to frequency point 1 and PCI 2 and the cell corresponding to frequency point 1 and PCI 3 are collectively referred to as “serving cell L1 measurement” in a broad sense. The definition rules above are not limited in the present disclosure.

In summary, the terminal device is capable of performing the neighbor cell L1 measurement based on the L1 measurement configuration, extending the usage scope of the L1 measurement. Compared to the L3 measurement mechanism, the L1 measurement mechanism reduces the service interruption delay of the terminal device in frequent handover scenarios.

Compared to handovers triggered by L3 signaling, handovers triggered by L1/L2 signaling have the advantages of low processing delay and small interruption delay. However, L1/L2 signaling-triggered handovers require the assistance of an L1 measurement mechanism, but the L1 measurement mechanism in the related art only involves the L1 measurement within the serving cell and cannot meet the requirement for the L1 measurement of a non-serving cell. The method provided according to the present disclosure extends the use scope of the L1 measurement, providing a more suitable and efficient measurement mechanism for L1/L2 signaling-triggered handover modes. Compared to using an L3 measurement to trigger handovers, this method is more suitable for L1/L2 signaling-triggered handover modes, reducing the service interruption delay of terminal devices in frequent handover scenarios.

FIG. 3 illustrates a flowchart of a method for cell measurement according to some exemplary embodiments of the present disclosure. Description is given based on an example in which the method is applicable to a terminal device. The method includes the following processes.

In process 320, neighbor cell L1 measurement is performed based on a configuration of a measurement reference signal.

In some embodiments, the L1 measurement configuration in process 220 includes the configuration of the measurement reference signal, wherein the configuration of the measurement reference signal is defined to perform the neighbor cell L1 measurement. In some embodiments, the measurement reference signal includes an SSB, and the configuration of the measurement reference signal includes the configuration corresponding to the SSB resource of a to-be-measured neighbor cell; or, the measurement reference signal includes a CSI-RS, and the configuration of the measurement reference signal includes the configuration corresponding to the CSI-RS resource of the to-be-measured neighbor cell; or, the measurement reference signal includes the SSB and the CSI-RS, and the configuration of the measurement reference signal includes the configuration corresponding to the SSB resource of the to-be-measured neighbor cell and the configuration corresponding to the CSI-RS resource of the to-be-measured neighbor cell.

For the case where the measurement reference signal includes an SSB, in some embodiments, the configuration corresponding to the SSB resource of the to-be-measured neighbor cell includes at least one of:
a cell identifier of the to-be-measured neighbor cell;
at least one SSB identifier of the to-be-measured neighbor cell; and
a configuration of a reference signal measurement window corresponding to the SSB resource of the to-be-measured neighbor cell.

In some embodiments, the configuration of the reference signal measurement window indicates the time-domain resource position of the SSB resource of the to-be-measured neighbor cell, facilitating the terminal device to accurately measure the SSB reference signal of the neighbor cell and acquire the measurement result.

In some embodiments, the methods for configuring the configuration of the reference signal measurement window include at least the following three methods.

First possible configuration method: The neighbor cell L1 measurement fully reuses the measurement window configuration defined for the corresponding frequency point in the L3 measurement configuration.

In some embodiments, the neighbor cell L1 measurement fully reuses the measurement window configuration defined for the corresponding frequency point in the L3 measurement configuration, which may be alternatively stated as the measurement window configuration corresponding to the neighbor cell L1 measurement being the same as the measurement window configuration defined for the corresponding frequency point in the L3 measurement configuration.

In some embodiments, the L3 measurement configuration is defined for the terminal device to perform L3 measurement on the neighbor cell based on the L3 measurement configuration. The L3 measurement configuration includes the measurement window configuration for the corresponding frequency point, as shown in Table 1 below:

TABLE 1
L3 measurement configuration includes the following information

| | | | |
|---|---|---|---|
| Frequency point identifier 1 | Frequency point | . . . | Frequency point |
| | identifier 2 | | identifier N |
| Measurement window | Measurement window | . . . | Measurement |
| configuration 1 | configuration 2 | | window |
| | | | configuration N |
| Optional, PCI list configuration 1 | Optional, PCI list | . . . | Optional, PCI list |
| | configuration 2 | | configuration N |
| Other configurations | Other configurations | . . . | Other |
| | | | configurations |

N represents a positive integer greater than or equal to 1.

Exemplarily, the neighbor cell L1 measurement is the neighbor cell L1 measurement for frequency point 2, and in the case that the neighbor cell L1 measurement reuses the measurement window configuration for the corresponding frequency point in the L3 measurement configuration, then the neighbor cell L1 measurement for frequency point 2 should use the measurement window configuration 2 associated with frequency point identifier 2 in Table 1.

Second possible configuration method: The neighbor cell L1 measurement independently configures the corresponding measurement window configuration. That is, the neighbor cell L1 measurement and the L3 measurement each independently configure their measurement window configurations.

In some embodiments, the neighbor cell L1 measurement independently configures the corresponding measurement window configuration, which may be alternatively stated as the measurement window configuration corresponding to the neighbor cell L1 measurement being different from the measurement window configuration defined for the corresponding frequency point in the L3 measurement configuration, or the measurement window configuration corresponding to the neighbor cell L1 measurement and the measurement window configuration defined for the corresponding frequency point in the L3 measurement configuration being mutually independent.

In some embodiments, the measurement window configuration in the L1 measurement configuration is as shown in Table 2:

TABLE 2
L1 measurement configuration includes the following information

| | | | |
|---|---|---|---|
| SSB resource configuration | SSB resource configuration | . . . | SSB resource configuration |
| and/or CSI-RS resource | and/or CSI-RS resource | . . . | and/or CSI-RS resource |
| configuration | configuration | | configuration |
| Measurement window | Measurement window | . . . | Measurement window |
| configuration 1 | configuration 2 | . . . | configuration M |
| Other configurations | Other configurations | . . . | Other configurations |
| | | . . . | |

M represents a positive integer greater than or equal to 1.

In some embodiments, the measurement window configuration corresponding to the L1 measurement in Table 2 is defined based on PCI granularity; or based on the combined granularity of frequency point and PCI; or based on cell granularity. Alternatively, the measurement window configuration corresponding to the L1 measurement is defined based on SSB resource or CSI-RS resource granularity. The configuration granularity on which the measurement window configuration corresponding to the L1 measurement is based is not limited in the present disclosure.

In some embodiments, configuring based on PCI granularity means that a PCI or a group of PCIs (a group of PCIs corresponding to the same frequency point) configures a set of measurement window configurations.

In some embodiments, configuring based on the combined granularity of frequency point and PCI means that the combination of a frequency point and PCI or the combination of a group of frequency points and PCIs configures a set of measurement window configurations.

In some embodiments, configuring based on cell granularity means that a cell identifier or a group of cell identifiers configures a set of measurement window configurations.

In some embodiments, configuring based on SSB resource or CSI-RS resource granularity means that a set of measurement window configurations corresponds to a group of SSB resource configurations and/or a group of CSI-RS resource configurations.

Third possible configuration method: The neighbor cell L1 measurement reuses part of the measurement window configuration defined for the corresponding frequency point in the L3 measurement configuration.

In some embodiments, the neighbor cell L1 measurement reuses part of the measurement window configuration defined for the corresponding frequency point in the L3 measurement configuration, which may be alternatively stated as part or all of the measurement window configuration corresponding to the neighbor cell L1 measurement being the same as part or all of the measurement window configuration defined for the corresponding frequency point in the L3 measurement configuration.

The third possible configuration method is a combination of the aforementioned first and second possible configuration methods. In some embodiments, the measurement window configuration includes three parameters: the periodicity of occurrence of the reference signal measurement window, the offset within the periodicity of occurrence of the reference signal measurement window, and the duration configuration of the reference signal measurement window. However, in the case that for the same frequency-domain resource, part of the parameter configuration values of the measurement window configuration corresponding to the L3 measurement are identical to those of the measurement window configuration corresponding to the L1 measurement, then the measurement window configuration corresponding to the L1 measurement for the corresponding frequency-domain resource only needs to configure the differing parts, while the remaining parts still reuse the measurement window configuration corresponding to the L3 measurement for the corresponding frequency-domain resource. This method can save configuration signaling overhead.

In some embodiments, the third possible configuration method is as shown in Table 3 below:

TABLE 3
Measurement window configuration corresponding to L1 measurement
includes the following information:
Parameter 1: periodicity of occurrence of the reference signal
measurement window
Parameter 2: offset within the periodicity of occurrence of the
reference signal measurement window
Parameter 3: duration configuration of the reference signal
measurement window

As shown in Table 3, in the case that part of the parameters in the measurement window configuration corresponding to the neighbor cell L1 measurement are not configured or do not occur, it is considered that the parameter values are identical to the values of the same parameters in the measurement window configuration corresponding to the L3 measurement configuration for the same frequency-domain resource. Conversely, in the case that part of the parameters in the measurement window configuration corresponding to the neighbor cell L1 measurement are configured or occur, the corresponding parameters included in the measurement window configuration corresponding to the neighbor cell L1 measurement are used to perform the neighbor cell L1 measurement.

Exemplarily, for a frequency-domain resource, in the case that the measurement window configuration corresponding to the frequency-domain resource in the L1 measurement configuration only includes parameter 1, then parameter 2 and parameter 3 in the L1 measurement window configuration corresponding to the frequency-domain resource should use parameter 2 and parameter 3 in the measurement window configuration corresponding to the L3 measurement configuration for the same frequency-domain resource.

In some embodiments, for the aforementioned second and/or third possible configuration methods, the configuration of the reference signal measurement window includes at least one of:
a periodicity of occurrence of the reference signal measurement window;
an offset within the periodicity of occurrence of the reference signal measurement window;
a duration of the reference signal measurement window; or
cell identification information corresponding to the time reference cell associated with the reference signal measurement window.

Since the time-domain measurement window corresponding to the configuration of the reference signal measurement window is a relative time window, a reference time needs to be determined for it to function. Generally, the reference time corresponding to the configuration of the reference signal measurement window is the serving cell time. In this case, if the cell identification information corresponding to the time reference cell associated with the reference signal measurement window does not occur or is not defined, it indicates that the reference signal measurement window defaults to using the serving cell time as the reference time. However, in the case that the reference time corresponding to the reference signal measurement window is not the serving cell, the cell identification information corresponding to the time reference cell associated with the reference signal measurement window needs to explicitly indicate which cell's time is used as the reference time for the reference signal measurement window.

In other embodiments, the third possible configuration method is further optimized:

The configuration of the reference signal measurement window for L1 only configures the differential part of the same parameter with different values.

Exemplarily, for a frequency-domain resource, in the case that the configuration of the reference signal measurement window corresponding to the frequency-domain resource in the L1 measurement configuration only includes the differential part of parameter 1, then parameter 2 and parameter 3 in the configuration of the reference signal measurement window corresponding to the frequency-domain resource should use parameter 2 and parameter 3 in the reference signal window configuration corresponding to the L3 measurement configuration for the same frequency-domain resource.

The value of parameter 1 in the reference signal window configuration for the L1 measurement corresponding to the frequency-domain resource is equal to parameter 1 in the reference signal window configuration corresponding to the L3 measurement for the same frequency-domain resource plus or minus the difference value of parameter 1 included in the reference signal window configuration corresponding to the frequency-domain resource in the L1 measurement configuration.

In a further optimized third possible embodiment, the configuration of the reference signal measurement window includes at least one of:
a deviation value of a first periodicity relative to a second periodicity, where the first periodicity is the periodicity of occurrence of the reference signal measurement window in the L1 measurement configuration, and the second periodicity is the corresponding periodicity in the SMTC in the MO associated with the corresponding frequency point in the L3 measurement configuration;
a deviation value of a first offset relative to a second offset, where the first offset is the offset within the periodicity of occurrence of the reference signal measurement window in the L1 measurement configuration, and the second offset is the offset within the corresponding periodicity in the SMTC in the MO associated with the corresponding frequency point in the L3 measurement configuration; or
a deviation value of a first duration relative to a second duration, where the first duration is the duration of the reference signal measurement window in the L1 measurement configuration, and the second duration is the duration of the corresponding reference signal measurement window in the SMTC in the MO associated with the corresponding frequency point in the L3 measurement configuration.

It should be understood that in the case that the L1 measurement configuration includes the configuration of the reference signal measurement window, the second or third possible configuration method is executed; in the case that the L1 measurement configuration does not include the configuration of the reference signal measurement window, the terminal device uses the first possible configuration method mentioned above to determine the reference signal measurement window required for performing neighbor cell L1 measurement.

In some embodiments, based on the first to third possible configuration methods mentioned above, prior to performing process 320 by the terminal device, the method further includes: in the case that the configuration of the reference signal measurement window does not occur or is not defined during a configuration process, using the configuration of the reference signal measurement window from the previous configuration process, or using the SMTC in the MO associated with the corresponding frequency point in the L3 measurement configuration.

For the case where the measurement reference signal includes a CSI-RS, in some embodiments, the configuration corresponding to the CSI-RS resource of the to-be-measured neighbor cell includes at least one of:
a cell identifier of the to-be-measured neighbor cell;
a logical identifier corresponding to at least one CSI-RS resource of the to-be-measured neighbor cell;
a time-domain resource configuration corresponding to at least one CSI-RS resource of the to-be-measured neighbor cell;
a frequency-domain resource configuration corresponding to at least one CSI-RS resource of the to-be-measured neighbor cell; and
a quasi co-location (QCL) reference signal configuration associated with at least one CSI-RS resource of the to-be-measured neighbor cell.

In some embodiments, the type of the QCL reference signal corresponding to the QCL reference signal configuration is an SSB or a CSI-RS.

It should be noted that in process 320, “performing neighbor cell L1 measurement” may be replaced with “performing serving cell L1 measurement”. In this case, “serving cell L1 measurement” includes both serving cell L1 measurement and neighbor cell L1 measurement. For a detailed explanation, reference is made to the description corresponding to process 220, which is not repeated herein.

In summary, the L1 measurement configuration includes the configuration of the measurement reference signal. An implementation method for using the L1 measurement configuration to perform the neighbor cell L1 measurement is further provided. Neighbor cell measurements are rapidly realized through the L1 measurement, ensuring the low-delay measurement requirement of the L1/L2 handover mechanism.

Based on the optional embodiment illustrated in FIG. 3, the configuration of the measurement reference signal may be configured according to different granularities. In some embodiments, the methods for configuring according to different granularities include at least the following three:
The configuration of measurement reference signal is defined based on PCI granularity.

In some embodiments, the configuration of the measurement reference signal being configured based on PCI granularity includes two possible meanings.
1. The configuration of the measurement reference signal is directly associated with PCI information.

In some embodiments, the configuration of the measurement reference signal further includes PCI information. For each PCI, a set of L1 measurement configurations corresponding to the SSB resource of the to-be-measured neighbor cell and/or L1 measurement configurations corresponding to the CSI-RS resource of the to-be-measured neighbor cell are directly associated.

Table 4 illustrates a schematic diagram of the configuration of the measurement reference signal directly associated with PCI granularity.

TABLE 4
The configuration of the measurement reference signal includes the following information

| PCI identifier 1 | PCI identifier 2 | PCI identifier 3 |
|---|---|---|
| L1 measurement configuration | L1 measurement configuration | L1 measurement configuration |
| corresponding to the SSB | corresponding to the SSB | corresponding to the SSB |
| resource of the to-be-measured | resource of the to-be-measured | resource of the to-be-measured |
| neighbor cell and/or L1 | neighbor cell and/or L1 | neighbor cell and/or L1 |
| measurement configuration | measurement configuration | measurement configuration |
| corresponding to the CSI-RS | corresponding to the CSI-RS | corresponding to the CSI-RS |
| resource of the to-be-measured | resource of the to-be-measured | resource of the to-be-measured |
| neighbor cell | neighbor cell | neighbor cell |

Exemplarily, Table 4 illustrates a scenario where the configuration of the measurement reference signal includes three PCI identifiers, and each PCI identifier is associated with a group of L1 measurement configurations corresponding to the SSB resource of the to-be-measured neighbor cell and/or L1 measurement configurations corresponding to the CSI-RS resource of the to-be-measured neighbor cell.

It should be noted that the present disclosure does not exclude the configuration form where a group of PCI identifiers configures a set of L1 measurement configurations corresponding to the SSB resource of the to-be-measured neighbor cell and/or L1 measurement configurations corresponding to the CSI-RS resource of the to-be-measured neighbor cell. An example is shown in Table 5.

TABLE 5
The configuration of the measurement reference signal includes the following information

| PCI identifier list 1 | PCI identifier list 2 | PCI identifier list 3 |
|---|---|---|
| L1 measurement configuration | L1 measurement configuration | L1 measurement configuration |
| corresponding to the SSB | corresponding to the SSB | corresponding to the SSB |
| resource of the to-be-measured | resource of the to-be-measured | resource of the to-be-measured |
| neighbor cell and/or L1 | neighbor cell and/or L1 | neighbor cell and/or L1 |
| measurement configuration | measurement configuration | measurement configuration |
| corresponding to the CSI-RS | corresponding to the CSI-RS | corresponding to the CSI-RS |
| resource of the to-be-measured | resource of the to-be-measured | resource of the to-be-measured |
| neighbor cell | neighbor cell | neighbor cell |

Unlike Table 4, in Table 5, a PCI identifier list includes one or more PCI identifiers, and each PCI identifier list is associated with a group of L1 measurement configurations corresponding to the SSB resource of the to-be-measured neighbor cell and/or L1 measurement configurations corresponding to the CSI-RS resource of the to-be-measured neighbor cell.
2. The configuration of the measurement reference signal is indirectly associated with PCI information.

In some embodiments, the configuration of the measurement reference signal further includes PCI information. For each PCI, a set of L1 measurement configurations corresponding to the SSB resource of the to-be-measured neighbor cell and/or L1 measurement configurations corresponding to the CSI-RS resource of the to-be-measured neighbor cell are indirectly associated.

Table 6 illustrates a schematic diagram of the configuration of the measurement reference signal indirectly associated with PCI information.

TABLE 6
The configuration of the measurement reference signal includes the following information

| Logical identifier 1 | Logical identifier 2 | Logical identifier 3 |
|---|---|---|
| L1 measurement configuration | L1 measurement configuration | L1 measurement configuration |
| corresponding to the SSB | corresponding to the SSB | corresponding to the SSB |
| resource of the to-be-measured | resource of the to-be-measured | resource of the to-be-measured |
| neighbor cell and/or L1 | neighbor cell and/or L1 | neighbor cell and/or L1 |
| measurement configuration | measurement configuration | measurement configuration |
| corresponding to the CSI-RS | corresponding to the CSI-RS | corresponding to the CSI-RS |
| resource of the to-be-measured | resource of the to-be-measured | resource of the to-be-measured |
| neighbor cell | neighbor cell | neighbor cell |

Table 7 illustrates a schematic structural diagram of configuration information related to the configuration of the measurement reference signal.

TABLE 7
Configuration related to the configuration of the measurement
reference signal includes the following information

| Logical identifier 1 | Logical identifier 2 | Logical identifier 3 |
|---|---|---|
| PCI identifier 1 or PCI | PCI identifier 2 or PCI | PCI identifier 3 or PCI |
| identifier list 1 | identifier list 2 | identifier list 3 |
| Other PCI granularity | Other PCI granularity | Other PCI granularity |
| parameters | parameters | parameters |

Combining Table 6 and Table 7, it can be seen that the configuration of the measurement reference signal does not directly include PCI identifiers or PCI identifier lists. However, each set of L1 measurement configurations corresponding to the SSB resource of the to-be-measured neighbor cell and/or L1 measurement configurations corresponding to the CSI-RS resource of the to-be-measured neighbor cell is indirectly associated with a PCI identifier or a group of PCI identifiers (i.e., a PCI identifier list) through a logical identifier (i.e., logical identifier 1, logical identifier 2, or logical identifier 3). The benefit of the indirect association is that in the case that the PCI-related parameters in Table 7 occur multiple times in other configuration parameters (such as the configuration of the measurement reference signal in Table 6), the other configuration parameters only need to add the corresponding logical identifier from Table 7 to their own configuration to achieve indirect parameter association. This method is more efficient in saving signaling overhead compared to directly adding PCI-related parameters each time.

In some embodiments, for the configuration of the measurement reference signal being defined based on PCI granularity (regardless of whether it belongs to the aforementioned direct or indirect association), the frequency points corresponding to these PCI information default to the same frequency point as the serving cell of the terminal device.
The configuration of the measurement reference signal is defined based on the combined granularity of frequency point and PCI.

In some embodiments, the configuration method based on the combined granularity of frequency point and PCI is similar to the configuration methods described in Tables 4 to 7. This configuration method also includes two possible meanings: direct association method (similar to the forms in Tables 4 and 5) and indirect association method (similar to the forms in Tables 6 and 7). The only difference is that the PCI identifiers in Tables 4 to 7 are replaced with the combination of frequency point identifiers and PCI identifiers; or the PCI identifier lists are replaced with combined lists of frequency point identifiers and PCI identifiers.

In some embodiments, for the configuration of the measurement reference signal being defined based on the combined granularity of frequency point and PCI (regardless of whether it belongs to the aforementioned direct or indirect association), the frequency point corresponding to the aforementioned frequency point identifier is either the frequency point corresponding to the serving cell or a different inter-frequency point from the frequency point corresponding to the serving cell.

In some embodiments, the configuration of the measurement reference signal includes the configuration of the measurement reference signal corresponding to the intra-frequency neighbor cell of the frequency point corresponding to the serving cell.

In some embodiments, the configuration of the measurement reference signal includes the configuration of the measurement reference signal corresponding to the inter-frequency neighbor cell with a different frequency point from the frequency point corresponding to the serving cell.

In some embodiments, the configuration of the measurement reference signal includes both the configuration of the measurement reference signal corresponding to the intra-frequency neighbor cell of the frequency point corresponding to the serving cell, and the configuration of the measurement reference signal corresponding to the inter-frequency neighbor cell with a different frequency point from the frequency point corresponding to the serving cell.
The configuration of measurement reference signal is defined based on cell granularity.

In some embodiments, the configuration method based on the cell granularity is similar to the configuration methods described in Tables 4 to 7. This configuration method also includes two possible meanings: direct association method (similar to the forms in Tables 4 and 5) and indirect association method (similar to the forms in Tables 6 and 7). The only difference is that the PCI identifiers in Tables 4 to 7 are replaced with cell identifiers; or the PCI identifier lists are replaced with cell identifier lists.

In some embodiments, the cell identifier is a cell logical identifier. For example, the cell identifier is represented in the form of a serving cell index; or the cell identifier is represented in the form of a global cell identity (CGI).

In summary, the configuration of the measurement reference signal may be configured based on PCI granularity, combined granularity of frequency point and PCI, or cell granularity. An implementation method for using the L1 measurement configuration to perform the neighbor cell L1 measurement is further provided. Neighbor cell measurements are rapidly implemented through the L1 measurement, ensuring the low-delay measurement requirement of the L1/L2 handover mechanism.

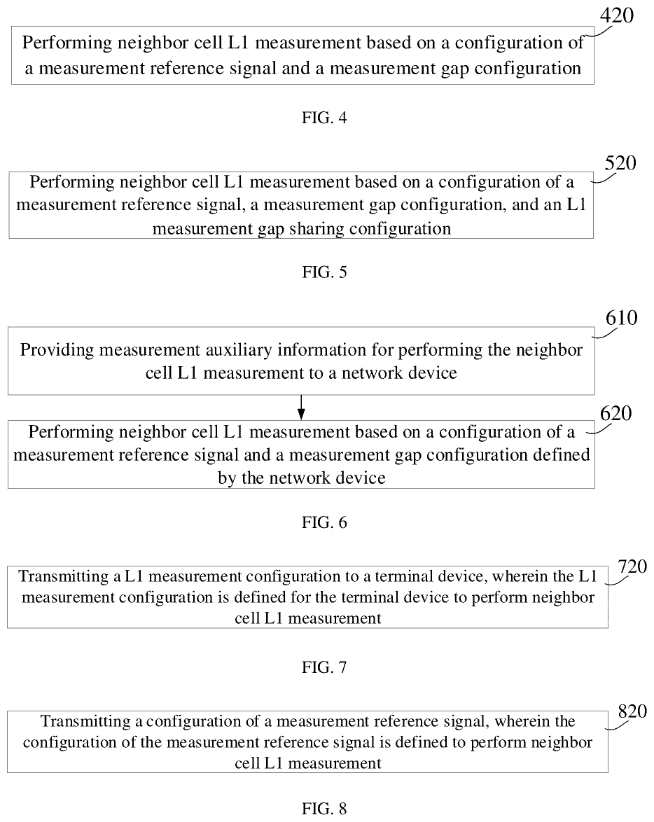

FIG. 4 illustrates a flowchart of a method for cell measurement according to some exemplary embodiments of the present disclosure. Description is given based on an example in which the method is applicable to a terminal device. The method includes the following processes.

In process 420, neighbor cell L1 measurement is performed based on a configuration of a measurement reference signal and a measurement gap configuration.

In some embodiments, the L1 measurement configuration in process 220 includes the configuration of the measurement reference signal for performing the neighbor cell L1 measurement and the measurement gap configuration for performing the neighbor cell L1 measurement.

In some embodiments, the configuration of the measurement reference signal includes the configuration corresponding to the SSB resource of a to-be-measured neighbor cell; or, the configuration of the measurement reference signal includes the configuration corresponding to the CSI-RS resource of the to-be-measured neighbor cell; or, the configuration of the measurement reference signal includes the configuration corresponding to the SSB resource of the to-be-measured neighbor cell and the configuration corresponding to the CSI-RS resource of the to-be-measured neighbor cell. The description of the configuration of the measurement reference signal has been detailed in the embodiment shown in FIG. 3 and is not repeated herein.

In some embodiments, the measurement gap configuration includes at least one of:
a periodicity of occurrence of the measurement window corresponding to the measurement gap configuration;
an offset within the periodicity of occurrence of the measurement window corresponding to the measurement gap configuration;
a duration of occurrence of the measurement window corresponding to the measurement gap configuration;
time advance of occurrence of the measurement window corresponding to the measurement gap configuration; or
an applicable range configuration corresponding to the measurement gap configuration.

In some embodiments, the applicable range configuration includes at least one of types:
an identifier corresponding to at least one cell applicable to the measurement gap configuration;
an identifier of at least one PCI applicable to the measurement gap configuration;
an identifier of at least one frequency point applicable to the measurement gap configuration;
an identifier of at least one SSB resource applicable to the measurement gap configuration; and
an identifier of at least one CSI-RS resource applicable to the measurement gap configuration.

In some embodiments, the methods for configuring the measurement gap configuration include at least the following three types:

First possible configuration method: The neighbor cell L1 measurement reuses the measurement gap of the L3 measurement configuration, that is, the neighbor cell L1 measurement does not independently configure the L1 measurement gap.

In some embodiments, the first possible configuration method needs to further address the issue of the measurement gap time allocation proportion between the L1 measurement and the L3 measurement, that is, how much time proportion in the measurement gap of the L3 measurement configuration is defined for performing the L1 measurement, and how much time proportion is configured for performing the L3 measurement.

Second possible configuration method: The measurement gap configuration is independently configured for the neighbor cell L1 measurement, that is, the measurement gap configuration used by the neighbor cell L1 measurement is different from the measurement gap configuration used by the L3 measurement.

In some embodiments, the second possible configuration method includes the following two sub-configuration methods:

Sub-method 1: All neighbor cell L1 measurements (including the SSB resource measurement and/or the CSI-RS resource measurement) share a single set of measurement gap configurations.

In some embodiments, the measurement gap configuration includes an applicable range configuration. Although all neighbor cell L1 measurements share a single set of measurement gap configurations under sub-method 1, certain neighbor cell L1 measurements (for example, intra-frequency neighbor cell L1 measurements) do not need to use the measurement gap and do not need to participate in the sharing of the measurement gap. Therefore, which neighbor cell L1 measurements need to share this set of measurement gap configurations are explicitly given by the applicable range configuration.

Sub-method 2: Multiple sets of L1 measurement gap configurations are configured for the neighbor cell L1 measurement.

In some embodiments, each set of L1 measurement gap configurations corresponds to a group of SSB resource measurements and/or a group of CSI-RS resource measurements.

In some embodiments, by the applicable range configuration, the corresponding relationship between each set of L1 measurement gap configurations and a group of SSB resources and/or a group of CSI-RS resources is explicitly given.

In some embodiments, by the implicit mapping relationship between the L1 measurement gap configuration list and the SSB resource and/or CSI-RS resource configuration list, the corresponding relationship between each set of L1 measurement gap configurations and a group of SSB resources and/or a group of CSI-RS resources is given. Exemplarily, the first set of L1 measurement gap configurations in the L1 measurement gap configuration list (the first element in the L1 measurement gap configuration list) corresponds to the first group of SSB resources and/or the first group of CSI-RS resources in the SSB resources and/or CSI-RS resource configuration list (the first element in the SSB resources and/or CSI-RS resource configuration list).

Third possible configuration method: In some cases, the measurement gap of the L3 measurement configuration is used; in other cases, no measurement gap is used; and in yet other cases, the measurement gap from the previous L1 measurement configuration is used.

In some embodiments, in the case that the measurement gap configuration does not occur or is not defined during a configuration process, the measurement gap configuration from the previous configuration process is used to perform the neighbor cell L1 measurement, or the measurement gap configuration defined in the L3 measurement configuration is used to perform the neighbor cell L1 measurement.

In some embodiments, in the case that the measurement gap configuration is in a deactivated state, the measurement gap configuration defined in the L3 measurement configuration is used to perform the neighbor cell L1 measurement, or no measurement gap configuration is used to perform the neighbor cell L1 measurement.

It should be noted that the present disclosure does not exclude the configuration method where the applicable range configuration corresponding to the measurement gap configuration is not included in the measurement gap configuration; that is, the applicable range configuration and the measurement gap configuration are independently and concurrently configured using two parameters.

Based on the first possible configuration method and the third possible configuration method, in the case of performing the neighbor cell L1 measurement, the measurement gap configuration defined in the L3 measurement configuration may be used. Therefore, in some embodiments, the terminal device also acquires the gap sharing configuration for the L3 measurement.

In some embodiments, the gap sharing configuration for the L3 measurement includes at least one of the following information:
a time proportion of the measurement gap configuration defined in the L3 measurement configuration that is occupied by the L3 measurement and the neighbor cell L1 measurement respectively;
a time proportion of the measurement gap configuration defined in the L3 measurement configuration that is occupied by the SSB resource measurement in the neighbor cell L1 measurement; and
a time proportion of the measurement gap configuration defined in the L3 measurement configuration that is occupied by the CSI-RS resource measurement in the neighbor cell L1 measurement.

In some embodiments, the terminal device acquires the gap sharing configuration for the L3 measurement by default; or, the terminal device acquires the gap sharing configuration for the L3 measurement by receiving terminal-specific signaling from a network device. In some embodiments, the default method is understood as a protocol-predefined method.

In some embodiments, prior to or upon process 420, the method further includes: receiving the first indication information from a network device, wherein the first indication information is configured to activate or deactivate the measurement gap configuration. In some embodiments, the first indication information is carried in any one of: an RRC message, a MAC CE message, or a DCI message.

It should be noted that in process 420, “performing neighbor cell L1 measurement” may be replaced with “performing serving cell L1 measurement”. In this case, “serving cell L1 measurement” includes both serving cell L1 measurement and neighbor cell L1 measurement. For a detailed explanation, reference is made to the description corresponding to process 220, which is not repeated herein.

In summary, the L1 measurement configuration includes the configuration of the measurement reference signal and the measurement gap configuration. An implementation method for using the L1 measurement configuration to perform the neighbor cell L1 measurement is further provided. Neighbor cell measurements are rapidly realized through the L1 measurement, ensuring the low-delay measurement requirement of the L1/L2 handover mechanism.

FIG. 5 illustrates a flowchart of a method for cell measurement according to some exemplary embodiments of the present disclosure. Description is given based on an example in which the method is applicable to a terminal device. The method includes the following processes.

In process 520, neighbor cell L1 measurement is performed based on a configuration of a measurement reference signal, a measurement gap configuration, and an L1 measurement gap sharing configuration.

In some embodiments, the L1 measurement configuration in process 220 includes the configuration of the measurement reference signal for performing the neighbor cell L1 measurement, the measurement gap configuration for performing the neighbor cell L1 measurement, and the L1 measurement gap sharing configuration for performing the neighbor cell L1 measurement.

In some embodiments, the L1 measurement configuration further includes the L1 measurement gap sharing configuration. The L1 measurement gap sharing configuration is used to configure the time proportion of the measurement gap configuration occupied by the SSB resource measurement in the neighbor cell L1 measurement, and/or the L1 measurement gap sharing configuration is used to configure the time proportion of the measurement gap configuration occupied by the CSI-RS resource measurement in the neighbor cell L1 measurement.

It should be noted that in process 520, “performing neighbor cell L1 measurement” may be replaced with “performing serving cell L1 measurement”. In this case, “serving cell L1 measurement” includes both serving cell L1 measurement and neighbor cell L1 measurement. For a detailed explanation, reference is made to the description corresponding to process 220, which is not repeated herein.

In summary, the L1 measurement configuration includes the configuration of the measurement reference signal, the measurement gap configuration, and the L1 measurement sharing configuration. An implementation method for using the L1 measurement configuration to perform the neighbor cell L1 measurement is further provided. Neighbor cell measurements are rapidly realized through the L1 measurement, ensuring the low-delay measurement requirement of the L1/L2 handover mechanism.

FIG. 6 illustrates a flowchart of a method for cell measurement according to some exemplary embodiments of the present disclosure. The method includes the following processes.

In process 610, measurement auxiliary information for performing the neighbor cell L1 measurement is provided to a network device.

In some embodiments, the measurement auxiliary information includes at least one of:
a cell identifier and the gap requirement indication information for the L1 measurement corresponding to each cell;
a frequency point identifier and the gap requirement indication information for the L1 measurement corresponding to each frequency point;
an SSB resource identifier and the gap requirement indication information for the L1 measurement corresponding to each SSB resource;
a CSI-RS resource identifier and the gap requirement indication information for the L1 measurement corresponding to each CSI-RS resource; and
a frequency band identifier and the gap requirement indication information for the L1 measurement corresponding to each frequency band.

In some embodiments, prior to process 610, the method further includes: receiving the second indication information from the network device, wherein the second indication information indicates whether to enable or disable the report function of the measurement auxiliary information. That is, the report function of the neighbor cell L1 measurement auxiliary information may be an optional function, and the report behavior can be activated or deactivated by the second indication information.

In some embodiments, the second indication information may be carried by any one of the following message types:
an RRC message;
a MAC CE message; and
a DCI message.

In process 620, neighbor cell L1 measurement is performed based on a configuration of a measurement reference signal and a measurement gap configuration defined by the network device.

It should be noted that process 620 is an optional process following the aforementioned process 610. In some embodiments, the terminal device performs process 610, then the terminal device receives a configuration message (including the configuration of the measurement reference signal and measurement gap configuration) from the network device, and subsequently, the terminal device performs process 620.

In some embodiments, the configuration of the measurement reference signal includes the configuration corresponding to the SSB resource of a to-be-measured neighbor cell; or, the configuration of the measurement reference signal includes the configuration corresponding to the CSI-RS resource of the to-be-measured neighbor cell; or, the configuration of the measurement reference signal includes the configuration corresponding to the SSB resource of the to-be-measured neighbor cell and the configuration corresponding to the CSI-RS resource of the to-be-measured neighbor cell. The description of the configuration of the measurement reference signal has been detailed in the embodiment shown in FIG. 3 and is not repeated herein.

In some embodiments, the measurement gap configuration includes at least one of:
a periodicity of occurrence of the measurement window corresponding to the measurement gap configuration;
an offset within the periodicity of occurrence of the measurement window corresponding to the measurement gap configuration;
a duration of occurrence of the measurement window corresponding to the measurement gap configuration;
time advance of the occurrence of the measurement window corresponding to the measurement gap configuration; or
an applicable range configuration corresponding to the measurement gap configuration.

The description of the measurement gap configuration has been detailed in the embodiment shown in FIG. 4 and is not repeated herein.

It should be noted that in process 620, “performing neighbor cell L1 measurement” may be replaced with “performing serving cell L1 measurement”. In this case, “serving cell L1 measurement” includes both serving cell L1 measurement and neighbor cell L1 measurement. For a detailed explanation, reference is made to the description corresponding to process 220, which is not repeated herein.

In summary, by transmitting measurement auxiliary information to the network device and transmitting measurement gap requirements to the network device, and with the L1 measurement configuration including the configuration of the measurement reference signal and the measurement gap configuration, an implementation method for using the L1 measurement configuration to perform the neighbor cell L1 measurement is further provided. Neighbor cell measurements are rapidly implemented through the L1 measurement, ensuring the low-delay measurement requirement of the L1/L2 handover mechanism.

Based on the optional embodiments illustrated in FIGS. 3 to 6, in some embodiments, the object of the neighbor cell L1 measurement includes at least one intra-frequency neighbor cell of the serving cell, and/or at least one inter-frequency neighbor cell of the serving cell.

In some embodiments, L1 measurement distinguishes between serving cell L1 measurement and neighbor cell L1 measurement.

In some embodiments, the intra-frequency or inter-frequency neighbor cells and the serving cell are in either a time-synchronous scenario or a time-asynchronous scenario.

For the time-asynchronous scenario, the reference signal measurement window for the neighbor cell L1 measurement of the intra-frequency neighbor cell (e.g., SMTC) may be independently configured based on PCI granularity. That is, the neighbor cell with the same frequency point as the serving cell but different PCI is allowed to have a set of separately configured configuration of the reference signal measurement windows for the neighbor cell L1 measurement. Alternatively, for the time-asynchronous scenario, the intra-frequency neighbor cell reuses the configuration of the reference signal measurement window for the L1 measurement configured for the serving cell frequency point or reuses the configuration of the reference signal measurement window for the L3 measurement configured for the serving cell frequency point. In this configuration method, the terminal device needs to adjust the actual position of the reference signal measurement window based on the absolute time difference between the serving cell and the intra-frequency neighbor cell, to actually measure the measurement reference signal transmitted by the asynchronous intra-frequency neighbor cell.

In some embodiments, the protocol defines all the objects on which the terminal device performs the neighbor cell L1 measurement as the L1 measurement for the serving cell of the terminal device; that is, regardless of whether the L1 measurement configuration actually includes the L1 measurement configuration of one cell or the L1 measurement configuration of at least two cells (cells identified by PCI+frequency point), the terminal device will refer to all L1 measurements as an L1 measurement for the serving cell. Exemplarily, the identifier corresponding to the serving cell is frequency point 1 and PCI 1. Meanwhile, the serving cell has two intra-frequency neighbor cells, their corresponding identifiers being frequency point 1 and PCI 2, and frequency point 1 and PCI 3, respectively. The L1 measurement configuration of the serving cell simultaneously includes measurements for frequency point 1 and PCI 1, frequency point 1 and PCI 2, and frequency point 1 and PCI 3. In this case, L1 measurements of the three cells mentioned above are collectively referred to as the L1 measurement for the serving cell. The cells corresponding to frequency point 1 and PCI 2, and frequency point 1 and PCI 3, and the serving cell corresponding to frequency point 1 and PCI 1 are either in a time-synchronous scenario or a time-asynchronous scenario.

In summary, the object of the neighbor cell L1 measurement is defined to include at least one intra-frequency neighbor cell of the serving cell, and/or at least one inter-frequency neighbor cell of the serving cell. An implementation method for using the L1 measurement configuration to perform the neighbor cell L1 measurement is further provided. Neighbor cell measurements are rapidly realized through the L1 measurement, ensuring the low-delay measurement requirement of the L1/L2 handover mechanism.

Based on the optional embodiments illustrated in FIGS. 3 to 6, in some embodiments, the method for cell measurement further includes: receiving third indication information from the network device, where the third indication information is configured to activate or deactivate the neighbor cell L1 measurement function of the terminal device.

In some embodiments, the third indication information is carried in any one of: an RRC message, a MAC CE message, or a DCI message.

In summary, the third indication information is defined to activate or deactivate the neighbor cell L1 measurement function of the terminal device, such that the performing of the neighbor cell L1 measurement may be flexibly controlled and the measurement efficiency is improved.

Based on the optional embodiments illustrated in FIGS. 3 to 6, in some embodiments, the method for cell measurement further includes: transmitting capability indication information to the network device. The capability indication information indicates whether the terminal device has the capability to perform the neighbor cell L1 measurement, and/or the capability indication information indicates whether the terminal device has the capability to report the measurement auxiliary information of the neighbor cell L1 measurement.

In some embodiments, in the case that both functions (the capability to perform the neighbor cell L1 measurement and the capability to report the measurement auxiliary information) are defined, the two capabilities are indicated using their respective capability indication information, or the two capabilities share a single capability indication information. In the case that the two capabilities share a single capability indication information, the function of neighbor cell L1 measurement and the function of reporting neighbor cell L1 measurement auxiliary information are either both supported or both not supported simultaneously.

In summary, by defining the capability indication information to indicate whether the terminal device has the capability to perform the neighbor cell L1 measurement, and/or whether the terminal device has the capability to report the measurement auxiliary information of the neighbor cell L1 measurement, the network device can flexibly control the activation or deactivation of the neighbor cell L1 measurement function of the terminal device. For example, the network device activates the aforementioned function for a terminal device that supports the capability, but does not activate the function for a terminal device that does not support the capability.

The detailed process of the terminal device performing the neighbor cell L1 measurement based on the L1 measurement configuration has been thoroughly described above. Next, the process of the network device configuring the L1 measurement configuration for the terminal device will be described.

FIG. 7 illustrates a flowchart of a method for cell measurement according to some exemplary embodiments of the present disclosure. Description is given based on an example in which the method is applicable to a network device. The method includes the following processes.

In process 720, a L1 measurement configuration is transmitted to a terminal device, wherein the L1 measurement configuration is defined for the terminal device to perform neighbor cell L1 measurement.

In some embodiments, the network device configures, for the terminal device, the configuration of the measurement reference signal for performing the neighbor cell L1 measurement.

Alternatively, the network device configures, for the terminal device, the configuration of the measurement reference signal for performing the neighbor cell L1 measurement, and the measurement gap configuration for performing the neighbor cell L1 measurement.

Alternatively, the network device configures, for the terminal device, the configuration of the measurement reference signal for performing the neighbor cell L1 measurement, the measurement gap configuration for performing the neighbor cell L1 measurement, and the L1 measurement gap sharing configuration for performing the neighbor cell L1 measurement.

In some embodiments, the network device configures, for the terminal device, the L1 measurement configuration for performing the serving cell measurement and/or the neighbor cell L1 measurement through any one of the following messages:
an RRC message;
a system broadcast message;
a MAC CE message; and
a DCI message.

In some embodiments, the network device performs configuration addition, configuration update, configuration deletion, or configuration deactivation operations for the terminal device through any one of the following messages:
an RRC message;
a system broadcast message;
a MAC CE message; and
a DCI message.

It should be noted that in process 720, “performing neighbor cell L1 measurement” may be replaced with “performing serving cell L1 measurement”. In this case, “serving cell L1 measurement” includes both serving cell L1 measurement and neighbor cell L1 measurement. This is because, in the case of executing the L1 measurement task, the network device transmits the serving cell L1 measurement-related configuration and the neighbor cell L1 measurement-related configuration to the terminal device, and the terminal device may not distinguish between measurements for the serving cell and the neighbor cell. Exemplarily, the network device transmits the L1 measurement-related configurations for the serving cell with frequency point 1 and PCI 1, the neighbor cell with frequency point 1 and PCI 2, and the neighbor cell with frequency point 1 and PCI 3 to the terminal device, and the terminal device performs L1 measurements on the cells above. Under one definition rule, serving cell L1 measurement only includes the L1 measurement for the cell corresponding to frequency point 1 and PCI 1, while L1 measurements for the cells corresponding to frequency point 1 and PCI 2 and frequency point 1 and PCI 3 are referred to as neighbor cell L1 measurements. Under another definition rule, the L1 measurement for the cell corresponding to frequency point 1 and PCI 1 and the L1 measurements for the cells corresponding to frequency point 1 and PCI 2 and frequency point 1 and PCI 3 are collectively referred to as “serving cell L1 measurement” in a broad sense. The definition rules above are not limited in the present disclosure.

In summary, the network device configures the L1 measurement configuration for the terminal device, enabling the terminal device to perform the neighbor cell L1 measurement based on the L1 measurement configuration. In this way, the usage scope of L1 measurement is extended. Compared to the L3 measurement mechanism, the L1 measurement mechanism reduces the service interruption delay of terminal devices in frequent handover scenarios.

FIG. 8 illustrates a flowchart of a method for cell measurement according to some exemplary embodiments of the present disclosure. Description is given based on an example in which the method is applicable to a network device. The method includes the following processes.

In process 820, a configuration of a measurement reference signal is transmitted to the terminal device, wherein the configuration of the measurement reference signal is defined to perform neighbor cell L1 measurement.

In some embodiments, the measurement reference signal includes an SSB, and the configuration of the measurement reference signal includes the configuration corresponding to the SSB resource of the to-be-measured neighbor cell; or,
the measurement reference signal includes a CSI-RS, and the configuration of the measurement reference signal includes the configuration corresponding to the CSI-RS resource of the to-be-measured neighbor cell; or,
the measurement reference signal includes the SSB and the CSI-RS, and the configuration of the measurement reference signal includes the configuration corresponding to the SSB resource of the to-be-measured neighbor cell and the configuration corresponding to the CSI-RS resource of the to-be-measured neighbor cell.

In some embodiments, the configuration corresponding to the SSB resource of the to-be-measured neighbor cell includes at least one of:
a cell identifier of the to-be-measured neighbor cell;
at least one SSB identifier of the to-be-measured neighbor cell; and
a configuration of the reference signal measurement window corresponding to the SSB resource of the to-be-measured neighbor cell.

In some embodiments, the configuration of the reference signal measurement window includes at least one of:
a periodicity of occurrence of the reference signal measurement window;
an offset within the periodicity of occurrence of the reference signal measurement window;
a duration of the reference signal measurement window; and
cell identification information corresponding to the time reference cell associated with the reference signal measurement window.

Since the time-domain measurement window corresponding to the configuration of the reference signal measurement window is a relative time window, a reference time needs to be determined for it to function. Generally, the reference time corresponding to the configuration of the reference signal measurement window is the serving cell time. In this case, if the cell identification information corresponding to the time reference cell associated with the reference signal measurement window does not occur or is not defined, it indicates that the reference signal measurement window defaults to using the serving cell time as the reference time. However, in the case that the reference time corresponding to the reference signal measurement window is not the serving cell, the cell identification information corresponding to the time reference cell associated with the reference signal measurement window needs to explicitly indicate which cell's time is used as the reference time for the reference signal measurement window.

In some embodiments, the configuration of the reference signal measurement window includes at least one of:
a deviation value of a first periodicity relative to a second periodicity, wherein the first periodicity is the periodicity of occurrence of the reference signal measurement window in the L1 measurement configuration, and the second periodicity is the corresponding periodicity in the SMTC in the MO associated with the corresponding frequency point in the L3 measurement configuration;
a deviation value of a first offset relative to a second offset, wherein the first offset is the offset within the periodicity of occurrence of the reference signal measurement window in the L1 measurement configuration, and the second offset is the offset within the corresponding periodicity in the SMTC in the MO associated with the corresponding frequency point in the L3 measurement configuration; and
a deviation value of a first duration relative to a second duration, wherein the first duration is the duration of the reference signal measurement window in the L1 measurement configuration, and the second duration is the duration of the corresponding reference signal measurement window in the SMTC in the MO associated with the corresponding frequency point in the L3 measurement configuration.

In some embodiments, the configuration corresponding to the CSI-RS resource of the to-be-measured neighbor cell includes at least one of:
a cell identifier of the to-be-measured neighbor cell;
a logical identifier corresponding to at least one CSI-RS resource of the to-be-measured neighbor cell;
a time-domain resource configuration corresponding to at least one CSI-RS resource of the to-be-measured neighbor cell;
a frequency-domain resource configuration corresponding to at least one CSI-RS resource of the to-be-measured neighbor cell; and
a QCL reference signal configuration associated with at least one CSI-RS resource of the to-be-measured neighbor cell.

In some embodiments, the type of the QCL reference signal corresponding to the QCL reference signal configuration is an SSB or a CSI-RS.

For a detailed description of the configuration of the measurement reference signal for performing the neighbor cell L1 measurement that the network device configures for the terminal device, reference is made to the method embodiment illustrated in FIG. 3 above, which is not repeated herein.

It should be noted that in process 820, “performing neighbor cell L1 measurement” may be replaced with “performing serving cell L1 measurement”. In this case, “serving cell L1 measurement” includes both serving cell L1 measurement and neighbor cell L1 measurement. For a detailed explanation, reference is made to the description corresponding to process 720, which is not repeated herein.

In summary, the L1 measurement configuration includes the configuration of the measurement reference signal. An implementation method in which the network device configures the L1 measurement configuration for the terminal device, and the terminal device performs the neighbor cell L1 measurement based on the L1 measurement configuration is further provided. Neighbor cell measurements are rapidly realized through the L1 measurement, ensuring the low-delay measurement requirement of the L1/L2 handover mechanism.

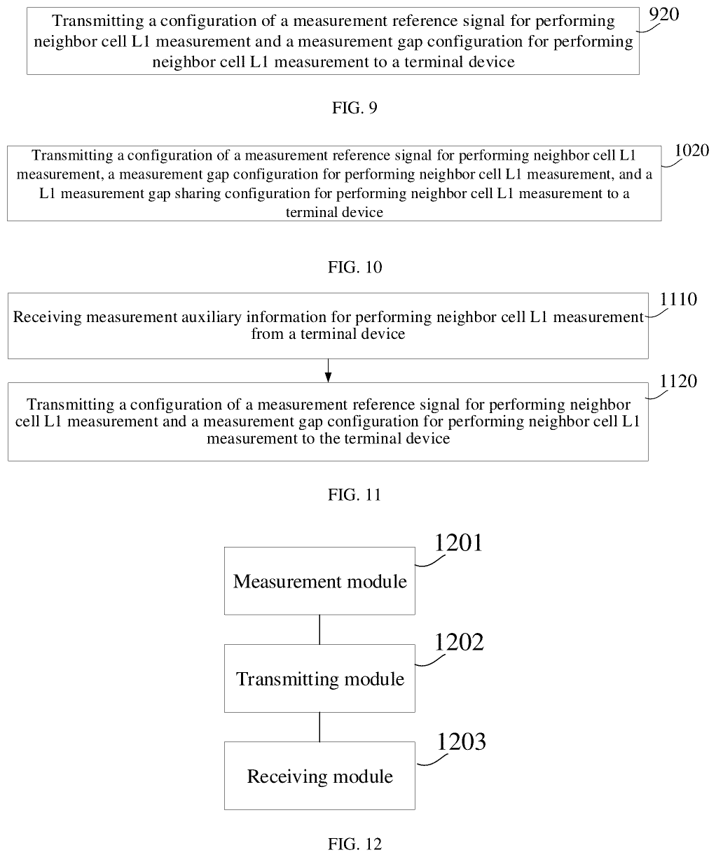

FIG. 9 illustrates a flowchart of a method for cell measurement according to some exemplary embodiments of the present disclosure. Description is given based on an example in which the method is applicable to a network device. The method includes the following processes.

In process 920, a configuration of a measurement reference signal for performing neighbor cell L1 measurement and a measurement gap configuration for performing neighbor cell L1 measurement are transmitted to a terminal device.

In some embodiments, for the content of the configuration of the measurement reference signal, reference is made to the method embodiment illustrated in FIG. 8, which is not repeated herein.

In some embodiments, the measurement gap configuration includes at least one of:
a periodicity of occurrence of the measurement window corresponding to the measurement gap configuration;
an offset within the periodicity of occurrence of the measurement window corresponding to the measurement gap configuration;
a duration of occurrence of the measurement window corresponding to the measurement gap configuration;
time advance of the occurrence of the measurement window corresponding to the measurement gap configuration; or
an applicable range configuration corresponding to the measurement gap configuration.

In some embodiments, the applicable range configuration includes at least one of types:
an identifier corresponding to at least one cell applicable to the measurement gap configuration;
an identifier of at least one PCI applicable to the measurement gap configuration;
an identifier of at least one frequency point applicable to the measurement gap configuration;
an identifier of at least one SSB resource applicable to the measurement gap configuration; and
an identifier of at least one CSI-RS resource applicable to the measurement gap configuration.

In some embodiments, the identifier corresponding to at least one cell is represented in any one of:
the form of a combination of frequency point and PCI;
the form of a CGI; or
the form of a serving cell index.

In some embodiments, prior to or upon process 920, the method further includes: transmitting the first indication information to the terminal device, where the first indication information is configured to activate or deactivate the measurement gap configuration. In some embodiments, the first indication information is carried in any one of: an RRC message, a MAC CE message, or a DCI message.

In some embodiments, prior to process 920, the method further includes: enabling the terminal device to acquire the gap sharing configuration for the L3 measurement by transmitting terminal-specific signaling to the terminal device. In some embodiments, the gap sharing configuration for the L3 measurement includes at least one of:
a time proportion of the measurement gap configuration defined in the L3 measurement configuration that is occupied by the L3 measurement and the neighbor cell L1 measurement respectively;
a time proportion of the measurement gap configuration defined in the L3 measurement configuration that is occupied by the SSB resource measurement in the neighbor cell L1 measurement; or
a time proportion of the measurement gap configuration defined in the L3 measurement configuration that is occupied by the CSI-RS resource measurement in the neighbor cell L1 measurement.

For a detailed description of the network device configuring, for the terminal device, the configuration of the measurement reference signal for performing the neighbor cell L1 measurement, and the measurement gap configuration for performing the neighbor cell L1 measurement, reference is made to the method embodiment illustrated in FIG. 4 above, which is not repeated herein.

It should be noted that in process 920, “performing neighbor cell L1 measurement” may be replaced with “performing serving cell L1 measurement”. In this case, “serving cell L1 measurement” includes both serving cell L1 measurement and neighbor cell L1 measurement. For a detailed explanation, reference is made to the description corresponding to process 720, which is not repeated herein.

In summary, the L1 measurement configuration includes the configuration of the measurement reference signal and the measurement gap configuration. An implementation method in which the network device configures the L1 measurement configuration for the terminal device, and the terminal device performs the neighbor cell L1 measurement based on the L1 measurement configuration is further provided. Neighbor cell measurements are rapidly realized through the L1 measurement, ensuring the low-delay measurement requirement of the L1/L2 handover mechanism.

FIG. 10 illustrates a flowchart of a method for cell measurement according to some exemplary embodiments of the present disclosure. Description is given based on an example in which the method is applicable to a network device. The method includes the following processes.

In process 1020, a configuration of a measurement reference signal for performing neighbor cell L1 measurement, a measurement gap configuration for performing neighbor cell L1 measurement, and a L1 measurement gap sharing configuration for performing neighbor cell L1 measurement are transmitted to a terminal device.

For the detailed content of the configuration of the measurement reference signal and the measurement gap configuration, reference is made to the method embodiment illustrated in FIG. 9 above.

In some embodiments, the L1 measurement gap sharing configuration includes:
a time proportion of the measurement gap configuration defined in the L1 measurement configuration that is occupied by the SSB resource measurement in the neighbor cell L1 measurement; and/or
a time proportion of the measurement gap configuration defined in the L1 measurement configuration that is occupied by the CSI-RS resource measurement in the neighbor cell L1 measurement.

For a detailed description of the network device configuring, for the terminal device, the configuration of the measurement reference signal for performing the neighbor cell L1 measurement, the measurement gap configuration for performing the neighbor cell L1 measurement, and the L1 measurement gap sharing configuration for performing the neighbor cell L1 measurement, reference is made to the method embodiment illustrated in FIG. 5 above, which is not repeated herein.

It should be noted that in process 1020, “performing neighbor cell L1 measurement” may be replaced with “performing serving cell L1 measurement”. In this case, “serving cell L1 measurement” includes both serving cell L1 measurement and neighbor cell L1 measurement. For a detailed explanation, reference is made to the description corresponding to process 720, which is not repeated herein.

In summary, the L1 measurement configuration includes the configuration of the measurement reference signal, the measurement gap configuration, and the L1 measurement sharing configuration. An implementation method in which the network device configures the L1 measurement configuration for the terminal device, and the terminal device performs the neighbor cell L1 measurement based on the L1 measurement configuration is further provided. Neighbor cell measurements are rapidly realized through the L1 measurement, ensuring the low-delay measurement requirement of the L1/L2 handover mechanism.

FIG. 11 illustrates a flowchart of a method for cell measurement according to some exemplary embodiments of the present disclosure. Description is given based on an example in which the method is applicable to a network device. The method includes the following processes.

In process 1110, measurement auxiliary information for performing neighbor cell L1 measurement from a terminal device is received.

In some embodiments, the measurement auxiliary information includes at least one of:
a cell identifier and the gap requirement indication information for the L1 measurement corresponding to each cell;
a frequency point identifier and the gap requirement indication information for the L1 measurement corresponding to each frequency point;
an SSB resource identifier and the gap requirement indication information for the L1 measurement corresponding to each SSB resource;
a CSI-RS resource identifier and the gap requirement indication information for the L1 measurement corresponding to each CSI-RS resource; and
a frequency band identifier and gap requirement indication information for the L1 measurement corresponding to each frequency band.

In some embodiments, prior to process 1110, the method further includes: transmitting second indication information to the terminal device, wherein the second indication information indicates whether to enable or disable the report function of the measurement auxiliary information.

For the detailed content of the measurement auxiliary information, reference is made to the method embodiment illustrated in FIG. 6.

In process 1120, a configuration of a measurement reference signal for performing neighbor cell L1 measurement and a measurement gap configuration for performing neighbor cell L1 measurement are transmitted to the terminal device.

It should be noted that process 1120 is an optional process following the aforementioned process 1110. In some embodiments, the network device performs process 1110, and then, the network device transmits a configuration message (including the configuration of the measurement reference signal and the measurement gap configuration) to the terminal device by performing process 1120.

In some embodiments, the configuration of the measurement reference signal includes the configuration corresponding to the SSB resource of a to-be-measured neighbor cell; or, the configuration of the measurement reference signal includes the configuration corresponding to the CSI-RS resource of the to-be-measured neighbor cell; or, the configuration of the measurement reference signal includes the configuration corresponding to the SSB resource of the to-be-measured neighbor cell and the configuration corresponding to the CSI-RS resource of the to-be-measured neighbor cell. The description of the configuration of the measurement reference signal has been detailed in the embodiment shown in FIG. 3 and is not repeated herein.

In some embodiments, the measurement gap configuration includes at least one of:
a periodicity of occurrence of the measurement window corresponding to the measurement gap configuration;
an offset within the periodicity of occurrence of the measurement window corresponding to the measurement gap configuration;
a duration of occurrence of the measurement window corresponding to the measurement gap configuration;
time advance of occurrence of the measurement window corresponding to the measurement gap configuration; or
an applicable range configuration corresponding to the measurement gap configuration.

For the detailed content of the configuration of the measurement reference signal and the measurement gap configuration, reference is made to the method embodiment illustrated in FIG. 10.

It should be noted that in process 1120, “performing neighbor cell L1 measurement” may be replaced with “performing serving cell L1 measurement”. In this case, “serving cell L1 measurement” includes both serving cell L1 measurement and neighbor cell L1 measurement. For a detailed explanation, reference is made to the description corresponding to process 720, which is not repeated herein.

In summary, by receiving the measurement auxiliary information from the terminal device and the measurement gap requirement from the terminal device, and with the L1 measurement configuration including the configuration of the measurement reference signal and the measurement gap configuration, an implementation method in which the network device configures the L1 measurement configuration for the terminal device, and the terminal device performs the neighbor cell L1 measurement based on the L1 measurement configuration is further provided. Neighbor cell measurements are rapidly realized through the L1 measurement, ensuring the low-delay measurement requirement of the L1/L2 handover mechanism.

Based on the optional embodiments illustrated in FIGS. 7 to 11, in some embodiments, the object of the neighbor cell L1 measurement includes at least one intra-frequency neighbor cell of the serving cell, and/or at least one inter-frequency neighbor cell of the serving cell.

In some embodiments, L1 measurement distinguishes between serving cell L1 measurement and neighbor cell L1 measurement.

In some embodiments, the intra-frequency or inter-frequency neighbor cells and the serving cell are in either a time-synchronous scenario or a time-asynchronous scenario.

For the time-asynchronous scenario, the reference signal measurement window for the neighbor cell L1 measurement of the intra-frequency neighbor cell (e.g., SMTC) may be independently configured based on PCI granularity. That is, the neighbor cell with the same frequency point as the serving cell but a different PCI is allowed to have a set of separately configured configuration of the reference signal measurement windows for the neighbor cell L1 measurement. Alternatively, for the time-asynchronous scenario, the intra-frequency neighbor cell reuses the configuration of the reference signal measurement window for the L1 measurement configured for the serving cell frequency point or reuses the configuration of the reference signal measurement window for the L3 measurement configured for the serving cell frequency point. In this configuration method, the terminal device needs to adjust the actual position of the reference signal measurement window based on the absolute time difference between the serving cell and the intra-frequency neighbor cell, to actually measure the measurement reference signal transmitted by the asynchronous intra-frequency neighbor cell.

In some embodiments, the protocol defines all the objects on which the terminal device performs the neighbor cell L1 measurement as the L1 measurement for the serving cell of the terminal device; that is, regardless of whether the L1 measurement configuration actually includes the L1 measurement configuration of one cell or the L1 measurement configuration of at least two cells (cells identified by PCI+frequency point), the terminal device will refer to all L1 measurements as an L1 measurement for the serving cell. Exemplarily, the identifier corresponding to the serving cell is frequency point 1 and PCI 1. Meanwhile, the serving cell has two intra-frequency neighbor cells, their corresponding identifiers being frequency point 1 and PCI 2, and frequency point 1 and PCI 3, respectively. The L1 measurement configuration of the serving cell simultaneously includes measurements for frequency point 1 and PCI 1, frequency point 1 and PCI 2, and frequency point 1 and PCI 3. In this case, the L1 measurements of the three cells mentioned above are collectively referred to as the L1 measurement for the serving cell. The cells corresponding to frequency point 1 and PCI 2, and frequency point 1 and PCI 3, and the serving cell corresponding to frequency point 1 and PCI 1 are either in a time-synchronous scenario or a time-asynchronous scenario.

In summary, the object of the neighbor cell L1 measurement is defined to include at least one intra-frequency neighbor cell of the serving cell, and/or at least one inter-frequency neighbor cell of the serving cell. An implementation method in which the network device configures the L1 measurement configuration for the terminal device, and the terminal device performs the neighbor cell L1 measurement based on the L1 measurement configuration is further provided. Neighbor cell measurements are rapidly realized through the L1 measurement, ensuring the low-delay measurement requirement of the L1/L2 handover mechanism.

Based on the optional embodiments illustrated in FIGS. 7 to 11, in some embodiments, the method for cell measurement further includes: transmitting third indication information to the terminal device, wherein the third indication information is configured to activate or deactivate the neighbor cell L1 measurement function of the terminal device.

In some embodiments, the third indication information is carried in any one of: an RRC message, a MAC CE message, or a DCI message.

In summary, the third indication information is defined to activate or deactivate the neighbor cell L1 measurement function of the terminal device, such that the performing of the neighbor cell L1 measurement may be flexibly control and measurement efficiency is improved.

Based on the optional embodiments illustrated in FIGS. 7 to 11, in some embodiments, the method for cell measurement further includes: receiving the capability indication information from the terminal device. The capability indication information indicates whether the terminal device has the capability to perform the neighbor cell L1 measurement, and/or the capability indication information indicates whether the terminal device has the capability to report the measurement auxiliary information of the neighbor cell L1 measurement.

In some embodiments, in the case where both functions (the capability to perform the neighbor cell L1 measurement and the capability to report the measurement auxiliary information) are defined, the two capabilities are indicated using their respective capability indication information, or the two capabilities share a single capability indication information. In the case where the two capabilities share a single capability indication information, the function of neighbor cell L1 measurement and the function of reporting neighbor cell L1 measurement auxiliary information are either both supported or both not supported simultaneously.

In summary, by defining the capability indication information to indicate whether the terminal device has the capability to perform the neighbor cell L1 measurement, and/or whether the terminal device has the capability to report the measurement auxiliary information of the neighbor cell L1 measurement, the network device flexibly controls the activation or deactivation of the neighbor cell L1 measurement function of the terminal device. For example, the network device activates the aforementioned function for a terminal device that supports the capability, but does not activate the function for a terminal device that does not support the capability.

FIG. 12 illustrates a structural block diagram of an apparatus for cell measurement according to some exemplary embodiments of the present disclosure. The apparatus includes:

a measurement module 1201, configured to perform neighbor cell L1 measurement based on an L1 measurement configuration.

In some embodiments, the L1 measurement configuration includes a configuration of a measurement reference signal, wherein the configuration of the measurement reference signal is defined to perform the neighbor cell L1 measurement.

In some embodiments, the measurement reference signal includes an SSB, and the configuration of the measurement reference signal includes the configuration corresponding to an SSB resource of the to-be-measured neighbor cell; or
the measurement reference signal includes a CSI-RS, and the configuration of the measurement reference signal includes the configuration corresponding to a CSI-RS resource of a to-be-measured neighbor cell; or
the measurement reference signal includes an SSB and a CSI-RS, and the configuration of the measurement reference signal includes a configuration corresponding to an SSB resource of a to-be-measured neighbor cell and a configuration corresponding to a CSI-RS resource of the to-be-measured neighbor cell.

In some embodiments, the configuration corresponding to the SSB resource of the to-be-measured neighbor cell includes at least one of:
a cell identifier of the to-be-measured neighbor cell;
at least one SSB identifier of the to-be-measured neighbor cell; or
a configuration of a reference signal measurement window corresponding to the SSB resource of the to-be-measured neighbor cell.

In some embodiments, the configuration of the reference signal measurement window includes at least one of:
a periodicity of occurrence of the reference signal measurement window;
an offset within a periodicity of occurrence of the reference signal measurement window;
a duration of the reference signal measurement window; or
cell identification information corresponding to a time reference cell associated with the reference signal measurement window.

In some embodiments, the configuration of the reference signal measurement window includes at least one of:
a deviation value of a first periodicity relative to a second periodicity, where the first periodicity is the periodicity of occurrence of the reference signal measurement window in the L1 measurement configuration, and the second periodicity is the corresponding periodicity in the SMTC in the MO associated with the corresponding frequency point in the L3 measurement configuration;
a deviation value of a first offset relative to a second offset, where the first offset is the offset within the periodicity of occurrence of the reference signal measurement window in the L1 measurement configuration, and the second offset is the offset within the corresponding periodicity in the SMTC in the MO associated with the corresponding frequency point in the L3 measurement configuration; or
a deviation value of a first duration relative to a second duration, where the first duration is the duration of the reference signal measurement window in the L1 measurement configuration, and the second duration is the duration of the corresponding reference signal measurement window in the SMTC in the MO associated with the corresponding frequency point in the L3 measurement configuration.

In some embodiments, the configuration corresponding to the SSB resource of the to-be-measured neighbor cell includes the configuration of the reference signal measurement window. The measurement module 1201 is further configured to, in the case that the configuration of the reference signal measurement window does not occur or is not defined in a configuration process, use the configuration of the reference signal measurement window from the previous configuration process, or use the SMTC in the MO associated with the corresponding frequency point in the L3 measurement configuration.

In some embodiments, the configuration corresponding to the CSI-RS resource of the to-be-measured neighbor cell includes at least one of:
a cell identifier of the to-be-measured neighbor cell;
a logical identifier corresponding to at least one CSI-RS resource of the to-be-measured neighbor cell;
a time-domain resource configuration corresponding to at least one CSI-RS resource of the to-be-measured neighbor cell;
a frequency-domain resource configuration corresponding to at least one CSI-RS resource of the to-be-measured neighbor cell; or
a QCL reference signal configuration associated with at least one CSI-RS resource of the to-be-measured neighbor cell.

In some embodiments, the type of the QCL reference signal corresponding to the QCL reference signal configuration is an SSB or a CSI-RS.

In some embodiments, the configuration of the measurement reference signal is defined based on a PCI granularity; or
the configuration of the measurement reference signal is defined based on a combined granularity of frequency point and PCI; or
the configuration of the measurement reference signal is defined based on a cell granularity.

In some embodiments, the L1 measurement configuration further includes a measurement gap configuration for performing the neighbor cell L1 measurement.

In some embodiments, the measurement gap configuration includes at least one of information:
a periodicity of occurrence of the measurement window corresponding to the measurement gap configuration;
an offset within the periodicity of occurrence of the measurement window corresponding to the measurement gap configuration;
a duration of occurrence of the measurement window corresponding to the measurement gap configuration;
time advance of occurrence of the measurement window corresponding to the measurement gap configuration; or
an applicable range configuration corresponding to the measurement gap configuration.

In some embodiments, the applicable range configuration includes at least one of types:
an identifier corresponding to at least one cell applicable to the measurement gap configuration;
an identifier of at least one PCI applicable to the measurement gap configuration;
an identifier of at least one frequency point applicable to the measurement gap configuration;
an identifier of at least one SSB resource applicable to the measurement gap configuration; and
an identifier of at least one CSI-RS resource applicable to the measurement gap configuration.

In some embodiments, the identifier corresponding to at least one cell is represented in any one of:
the form of a combination of frequency point and PCI;
the form of a CGI; or
the form of a serving cell index.

In some embodiments, the apparatus further includes a receiving module 1203. The receiving module 1203 is configured to receive the first indication information from a network device, where the first indication information is configured to activate or deactivate the measurement gap configuration.

In some embodiments, the first indication information is carried in any one of:
an RRC message, a MAC CE message, or a DCI message.

In some embodiments, the measurement module 1201 is further configured to, in the case that the measurement gap configuration does not occur or is not defined during a configuration process, perform the neighbor cell L1 measurement using the measurement gap configuration from the previous configuration process, or perform the neighbor cell L1 measurement using the measurement gap configuration defined in the L3 measurement configuration.

In some embodiments, the measurement module 1201 is further configured to, in the case that the measurement gap configuration is in a deactivated state, perform the neighbor cell L1 measurement using the measurement gap configuration defined in the L3 measurement configuration, or perform the neighbor cell L1 measurement without using any measurement gap configuration.

In some embodiments, the measurement module 1201 is further configured to acquire the gap sharing configuration for the L3 measurement when using the measurement gap configuration defined in the L3 measurement configuration.

In some embodiments, the gap sharing configuration for the L3 measurement includes at least one of:
a time proportion of the measurement gap configuration defined in the L3 measurement configuration that is occupied by the L3 measurement and the neighbor cell L1 measurement respectively;
a time proportion of the measurement gap configuration defined in the L3 measurement configuration that is occupied by the SSB resource measurement in the neighbor cell L1 measurement; or
a time proportion of the measurement gap configuration defined in the L3 measurement configuration that is occupied by the CSI-RS resource measurement in the neighbor cell L1 measurement.

In some embodiments, the measurement module 1201 is further configured to acquire the gap sharing configuration for the L3 measurement by default.

In some embodiments, the measurement module 1201 is further configured to acquire the gap sharing configuration for the L3 measurement by receiving terminal-specific signaling from a network device.

In some embodiments, the L1 measurement configuration further includes the L1 measurement gap sharing configuration for performing the neighbor cell L1 measurement.

In some embodiments, the L1 measurement gap sharing configuration includes:
a time proportion of the measurement gap configuration defined in the L1 measurement configuration that is occupied by the SSB resource measurement in the neighbor cell L1 measurement; and/or
a time proportion of the measurement gap configuration defined in the L1 measurement configuration that is occupied by the CSI-RS resource measurement in the neighbor cell L1 measurement.

In some embodiments, the apparatus further includes a transmitting module 1202. The transmitting module 1202 is configured to provide the measurement auxiliary information for performing the neighbor cell L1 measurement to a network device.

In some embodiments, the measurement auxiliary information includes at least one of:
a cell identifier and the gap requirement indication information for the L1 measurement corresponding to each cell;
a frequency point identifier and the gap requirement indication information for the L1 measurement corresponding to each frequency point;
an SSB resource identifier and the gap requirement indication information for the L1 measurement corresponding to each SSB resource;
a CSI-RS resource identifier and the gap requirement indication information for the L1 measurement corresponding to each CSI-RS resource; or
a frequency band identifier and the gap requirement indication information for the L1 measurement corresponding to each frequency band.

In some embodiments, the receiving module 1203 is further configured to receive the second indication information from the network device, where the second indication information indicates whether to enable or disable the report function of the measurement auxiliary information.

In some embodiments, the object of the neighbor cell L1 measurement includes:
at least one intra-frequency neighbor cell of the serving cell, and/or at least one inter-frequency neighbor cell of the serving cell.

In some embodiments, the receiving module 1203 is further configured to receive the third indication information from the network device, where the third indication information is configured to activate or deactivate the neighbor cell L1 measurement function of the terminal device.

In some embodiments, the third indication information is carried in any one of:
an RRC message, a MAC CE message, or a DCI message.

In some embodiments, the transmitting module 1202 is further configured to send the capability indication information to the network device.

The capability indication information indicates whether the terminal device has the capability to perform the neighbor cell L1 measurement, and/or the capability indication information indicates whether the terminal device has the capability to report the measurement auxiliary information of the neighbor cell L1 measurement.

In summary, the apparatus is capable of performing the neighbor cell L1 measurement based on the L1 measurement configuration, such that the usage scope of the L1 measurement is extended. Compared to the L3 measurement mechanism, the L1 measurement mechanism reduces the service interruption delay in frequent handover scenarios.

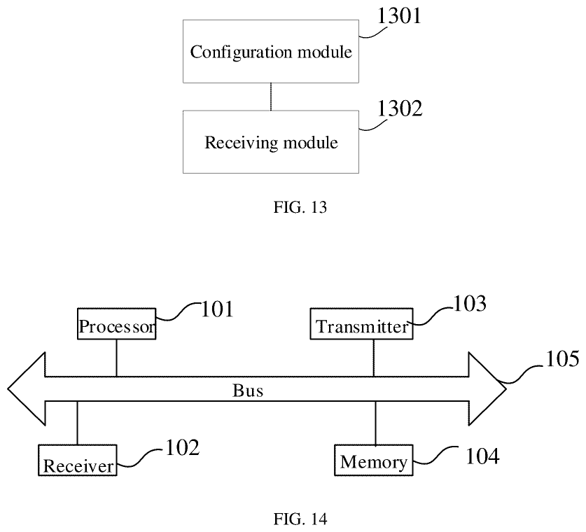

FIG. 13 illustrates a structural block diagram of an apparatus for cell measurement according to some exemplary embodiments of the present disclosure. The apparatus includes:
a configuration module 1301, operable to transmit the L1 measurement configuration to a terminal device, where the L1 measurement configuration is defined for the terminal device to perform the neighbor cell L1 measurement.

In some embodiments, the L1 measurement configuration includes a configuration of a measurement reference signal, wherein the configuration of the measurement reference signal is defined to perform the neighbor cell L1 measurement.

In some embodiments, the measurement reference signal includes an SSB, and the configuration of the measurement reference signal includes the configuration corresponding to the SSB resource of a to-be-measured neighbor cell; or, the measurement reference signal includes a CSI-RS, and the configuration of the measurement reference signal includes the configuration corresponding to the CSI-RS resource of the to-be-measured neighbor cell; or, the measurement reference signal includes the SSB and the CSI-RS, and the configuration of the measurement reference signal includes the configuration corresponding to the SSB resource of the to-be-measured neighbor cell and the configuration corresponding to the CSI-RS resource of the to-be-measured neighbor cell.

In some embodiments, the configuration corresponding to the SSB resource of the to-be-measured neighbor cell includes at least one of:
a cell identifier of the to-be-measured neighbor cell;
at least one SSB identifier of the to-be-measured neighbor cell; or
a configuration of a reference signal measurement window corresponding to the SSB resource of the to-be-measured neighbor cell.

In some embodiments, the configuration of the reference signal measurement window includes at least one of:
a periodicity of occurrence of the reference signal measurement window;
an offset within the periodicity of occurrence of the reference signal measurement window;
a duration of the reference signal measurement window; or
cell identification information corresponding to the time reference cell associated with the reference signal measurement window.

In some embodiments, the configuration of the reference signal measurement window includes at least one of:
a deviation value of a first periodicity relative to a second periodicity, wherein the first periodicity is the periodicity of occurrence of the reference signal measurement window in the L1 measurement configuration, and the second periodicity is the corresponding periodicity in the SMTC in the MO associated with the corresponding frequency point in the L3 measurement configuration;
a deviation value of a first offset relative to a second offset, where the first offset is the offset within the periodicity of occurrence of the reference signal measurement window in the L1 measurement configuration, and the second offset is the offset within the corresponding periodicity in the SMTC in the MO associated with the corresponding frequency point in the L3 measurement configuration; or
a deviation value of a first duration relative to a second duration, where the first duration is the duration of the reference signal measurement window in the L1 measurement configuration, and the second duration is the duration of the corresponding reference signal measurement window in the SMTC in the MO associated with the corresponding frequency point in the L3 measurement configuration.

In some embodiments, the configuration corresponding to the CSI-RS resource of the to-be-measured neighbor cell includes at least one of:
a cell identifier of the to-be-measured neighbor cell;
a logical identifier corresponding to at least one CSI-RS resource of the to-be-measured neighbor cell;
a time-domain resource configuration corresponding to at least one CSI-RS resource of the to-be-measured neighbor cell;
a frequency-domain resource configuration corresponding to at least one CSI-RS resource of the to-be-measured neighbor cell; or
a QCL reference signal configuration associated with at least one CSI-RS resource of the to-be-measured neighbor cell.

In some embodiments, the type of the QCL reference signal corresponding to the QCL reference signal configuration is an SSB or a CSI-RS.

In some embodiments, the configuration of the measurement reference signal is defined based on a PCI granularity; or the configuration of the measurement reference signal is defined based on a combined granularity of frequency point and PCI; or the configuration of the measurement reference signal is defined based on a cell granularity.

In some embodiments, the L1 measurement configuration further includes the measurement gap configuration for performing the neighbor cell L1 measurement.

In some embodiments, the measurement gap configuration includes at least one of information:
a periodicity of occurrence of the measurement window corresponding to the measurement gap configuration;
an offset within the periodicity of occurrence of the measurement window corresponding to the measurement gap configuration;
a duration of occurrence of the measurement window corresponding to the measurement gap configuration;
time advance of occurrence of the measurement window corresponding to the measurement gap configuration; or
an applicable range configuration corresponding to the measurement gap configuration.

In some embodiments, the applicable range configuration includes at least one of types:
an identifier corresponding to at least one cell applicable to the measurement gap configuration;
an identifier of at least one PCI applicable to the measurement gap configuration;
an identifier of at least one frequency point applicable to the measurement gap configuration;
an identifier of at least one SSB resource applicable to the measurement gap configuration; and
an identifier of at least one CSI-RS resource applicable to the measurement gap configuration.

In some embodiments, the identifier corresponding to at least one cell is represented in any one of:
the form of a combination of frequency point and PCI;
the form of a CGI; or
the form of a serving cell index.

In some embodiments, the configuration module 1301 is further operable to transmit the first indication information to the terminal device, where the first indication information is configured to activate or deactivate the measurement gap configuration.

In some embodiments, the first indication information is carried in any one of:
an RRC message, a MAC CE message, or a DCI message.

In some embodiments, the configuration module 1301 is further operable to enable the terminal device to obtain the gap sharing configuration for the L3 measurement by transmitting terminal-specific signaling to the terminal device.

In some embodiments, the gap sharing configuration for the L3 measurement includes at least one of:
a time proportion of the measurement gap configuration defined in the L3 measurement configuration that is occupied by the L3 measurement and the neighbor cell L1 measurement respectively;
a time proportion of the measurement gap configuration defined in the L3 measurement configuration that is occupied by the SSB resource measurement in the neighbor cell L1 measurement; or
a time proportion of the measurement gap configuration defined in the L3 measurement configuration that is occupied by the CSI-RS resource measurement in the neighbor cell L1 measurement.

In some embodiments, the L1 measurement configuration further includes the L1 measurement gap sharing configuration for performing the neighbor cell L1 measurement.

In some embodiments, the L1 measurement gap sharing configuration includes:
a time proportion of the measurement gap configuration defined in the L1 measurement configuration that is occupied by the SSB resource measurement in the neighbor cell L1 measurement; and/or, a time proportion of the measurement gap configuration defined in the L1 measurement configuration that is occupied by the CSI-RS resource measurement in the neighbor cell L1 measurement.

In some embodiments, the apparatus further includes a receiving module 1302. The receiving module 1302 is configured to receive the measurement auxiliary information for performing the neighbor cell L1 measurement provided by the terminal device.

In some embodiments, the measurement auxiliary information includes at least one of:
a cell identifier and the gap requirement indication information for the L1 measurement corresponding to each cell;
a frequency point identifier and the gap requirement indication information for the L1 measurement corresponding to each frequency point;
an SSB resource identifier and the gap requirement indication information for the L1 measurement corresponding to each SSB resource;
a CSI-RS resource identifier and the gap requirement indication information for the L1 measurement corresponding to each CSI-RS resource; or
a frequency band identifier and the gap requirement indication information for the L1 measurement corresponding to each frequency band.

In some embodiments, the configuration module 1301 is further operable to transmit the second indication information to the terminal device, where the second indication information indicates whether to enable or disable the report function of the measurement auxiliary information.

In some embodiments, the object of the neighbor cell L1 measurement includes at least one intra-frequency neighbor cell of the serving cell, and/or at least one inter-frequency neighbor cell of the serving cell.

In some embodiments, the configuration module 1301 is further operable to transmit the third indication information to the terminal device, where the third indication information is configured to activate or deactivate the neighbor cell L1 measurement function of the terminal device.

In some embodiments, the third indication information is carried in any one of:
an RRC message, a MAC CE message, or a DCI message.

In some embodiments, the receiving module 1302 is further configured to receive the capability indication information from the terminal device.

The capability indication information indicates whether the terminal device has the capability to perform the neighbor cell L1 measurement, and/or the capability indication information indicates whether the terminal device has the capability to report the measurement auxiliary information of the neighbor cell L1 measurement.

In summary, the apparatus configures the L1 measurement configuration for the terminal device, enabling the terminal device to perform the neighbor cell L1 measurement based on the L1 measurement configuration. This extends the usage scope of L1 measurement. Compared to the L3 measurement mechanism, the L1 measurement mechanism reduces the service interruption delay of terminal devices in frequent handover scenarios.

It should be noted that, in the case that the apparatus according to the above embodiments implements the functions thereof, the division of the functional modules is merely exemplary. In practice, the above functions may be assigned to and completed by different functional modules according to actual needs, i.e., the internal structure of the apparatus may be divided into different functional modules, to implement all or a part of the above functions.

With regard to the apparatus in the above embodiments, the specific manner in which each module performs the operation has been described in detail in the embodiments related to the method and will not be described in detail herein.

Referring to FIG. 17, which illustrates a schematic structural diagram of a communication device according to some embodiments of the present disclosure. The communication device may be a terminal device or a network device (base station). The communication device includes a processor 101, a receiver 102, a transmitter 103, and a memory 104.

The processor 101 includes one or more processing cores, and the processor 1701 runs various functional applications by running software programs and modules.

The receiver 102 and the transmitter 103 may be configured to receive and transmit information. The receiver 102 and the transmitter 103 can be housed on a single communication chip.

The memory 104 may be configured to store a computer program, and the processor 101 is configured to load and run the computer program to perform the various processes in the above method embodiments.

Furthermore, the memory 107 may be implemented by any type of volatile or non-volatile storage device, or combination thereof. The volatile or non-volatile storage devices include but are not limited to: a random-access memory (RAM), a read-only memory (ROM), an erasable programmable read-only memory (EPROM), an electrically erasable programmable read-only memory (EEPROM), a flash memory or other solid-state storage technologies, a compact disc read-only memory (CD-ROM), a high-density digital video disc (DVD) or other optical storage, magnetic cassette, magnetic tape, magnetic disc storage, or other magnetic storage devices.

The embodiments of the present disclosure further provide a computer-readable storage medium storing one or more computer program therein. The one or more computer programs, when loaded and run by a processor, cause the processor to perform the method for cell measurement described above.

In some embodiments, the computer-readable storage medium includes a ROM, a RAM, a solid state drives (SSD), an optical disc, or the like. The RAM includes a resistance random access memory (ReRAM) and a dynamic random access memory (DRAM).

The embodiments of the present disclosure further provide a chip including one or more programmable logic circuits and/or program instructions. The chip, when running, is caused to perform the method for cell measurement described above.

The embodiments of the present disclosure further provide a computer program product or a computer program. The computer program product or the computer program includes computer instructions stored in a computer-readable storage medium, and a processor reads and executes the computer instructions from the computer-readable storage medium to perform the method for cell measurement described above.

The processor in the embodiments of the present disclosure includes an application specific integrated circuit (ASIC).

It should be understood that the term “indication” mentioned in the embodiments of the present disclosure is a direct indication, an indirect indication, or an indication that there is an association relationship. For example, A indicates B, which may mean that A indicates B directly, e.g., B may be acquired by A; or that A indicates B indirectly, e.g., A indicates C by which B may be acquired; or that an association relationship is present between A and B.

In the description of the embodiments of the present disclosure, the term “correspond” indicates a direct or indirect corresponding relationship between two items, or indicates an associated relationship between two items. It may also indicate relationships such as indicating and being indicated, or configuring and being configured.

The term “a plurality of” herein means two or more. The term “and/or” describes an association relationship between the associated objects, and indicates that three relationships may be present. For example, the phrase “A and/or B” means (A), (B), or (A and B). The symbol “/” generally indicates an “or” relationship between the associated objects.

In addition, serial numbers of the processes described herein only show an exemplary possible sequence of performing the processes. In some other embodiments, the processes may also be performed out of the numbering sequence, for example, two processes with different serial numbers are performed simultaneously, or two processes with different serial numbers are performed in a reverse order to the illustrated sequence, which is not limited in the present disclosure.

Those skilled in the art should understand that in the one or more of the above embodiments, the functions described in the embodiments of the present disclosure may be implemented using hardware, software, firmware, or any combination thereof. The functions, when implemented by software, may be stored in a computer-readable medium or transmitted as one or more instructions or codes on a computer-readable medium. The computer-readable medium includes a computer storage medium and a communication medium, wherein the communication medium includes any medium that facilitates the transfer of a computer program from one place to another. The storage medium is any available medium that is accessible by a general-purpose or special-purpose computer.

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A method for cell measurement, applicable to a terminal device, the method comprising:
performing neighbor cell layer 1 (L1) measurement based on an L1 measurement configuration.

2. The method according to claim 1, wherein the L1 measurement configuration comprises a configuration of a measurement reference signal, wherein the configuration of the measurement reference signal is defined to perform the neighbor cell L1 measurement.

3. The method according to claim 2, wherein there is one of:
the measurement reference signal comprises a synchronization signal/physical broadcast channel block (SSB), and the configuration of the measurement reference signal comprises a configuration corresponding to an SSB resource of a to-be-measured neighbor cell;
the measurement reference signal comprises a channel state information reference signal (CSI-RS), and the configuration of the measurement reference signal comprises a configuration corresponding to a CSI-RS resource of a to-be-measured neighbor cell; or
the measurement reference signal comprises an SSB and a CSI-RS, and the configuration of the measurement reference signal comprises a configuration corresponding to an SSB resource of a to-be-measured neighbor cell and a configuration corresponding to a CSI-RS resource of the to-be-measured neighbor cell.

4. The method according to claim 3, wherein the configuration corresponding to the SSB resource of the to-be-measured neighbor cell comprises at least one of:
a cell identifier of the to-be-measured neighbor cell;
at least one SSB identifier of the to-be-measured neighbor cell; or
a configuration of a reference signal measurement window corresponding to the SSB resource of the to-be-measured neighbor cell.

5. The method according to claim 4, wherein the configuration of the reference signal measurement window comprises at least one of:
a periodicity of occurrence of the reference signal measurement window;
an offset within a periodicity of occurrence of the reference signal measurement window;
a duration of the reference signal measurement window; or
cell identification information corresponding to a time reference cell associated with the reference signal measurement window.

6. The method according to claim 1, wherein an object of the neighbor cell L1 measurement comprises at least one of:
at least one intra-frequency neighbor cell of a serving cell; or
at least one inter-frequency neighbor cell of the serving cell.

7. A terminal device, comprising: a processor; wherein the processor is configured to load and run a computer program, to cause the terminal device to:
perform neighbor cell layer 1 (L1) measurement based on an L1 measurement configuration.

8. The terminal device according to claim 7, wherein the L1 measurement configuration comprises a configuration of a measurement reference signal, wherein the configuration of the measurement reference signal is defined to perform the neighbor cell L1 measurement.

9. The terminal device according to claim 8, wherein there is one of:
the measurement reference signal comprises a synchronization signal/physical broadcast channel block (SSB), and the configuration of the measurement reference signal comprises a configuration corresponding to an SSB resource of a to-be-measured neighbor cell;
the measurement reference signal comprises a channel state information reference signal (CSI-RS), and the configuration of the measurement reference signal comprises a configuration corresponding to a CSI-RS resource of a to-be-measured neighbor cell; or
the measurement reference signal comprises an SSB and a CSI-RS, and the configuration of the measurement reference signal comprises a configuration corresponding to an SSB resource of a to-be-measured neighbor cell and a configuration corresponding to a CSI-RS resource of the to-be-measured neighbor cell.

10. The terminal device according to claim 9, wherein the configuration corresponding to the SSB resource of the to-be-measured neighbor cell comprises at least one of:
a cell identifier of the to-be-measured neighbor cell;
at least one SSB identifier of the to-be-measured neighbor cell; or
a configuration of a reference signal measurement window corresponding to the SSB resource of the to-be-measured neighbor cell.

11. The terminal device according to claim 9, wherein the configuration corresponding to the CSI-RS resource of the to-be-measured neighbor cell comprises at least one of:
a cell identifier of the to-be-measured neighbor cell;
a logical identifier corresponding to at least one CSI-RS resource of the to-be-measured neighbor cell;
a time-domain resource configuration corresponding to at least one CSI-RS resource of the to-be-measured neighbor cell;
a frequency-domain resource configuration corresponding to at least one CSI-RS resource of the to-be-measured neighbor cell; or
a quasi co-location (QCL) reference signal configuration associated with at least one CSI-RS resource of the to-be-measured neighbor cell.

12. The terminal device according to claim 8, wherein there is one of:
the configuration of the measurement reference signal is defined based on a physical cell identity (PCI) granularity;
the configuration of the measurement reference signal is defined based on a combined granularity of frequency point and PCI; or
the configuration of the measurement reference signal is defined based on a cell granularity.

13. A network device, comprising: a processor; wherein the processor is configured to load and run a computer program, to cause the network device to:
transmit a layer 1 (L1) measurement configuration to a terminal device, wherein the L1 measurement configuration is defined for the terminal device to perform neighbor cell L1 measurement.

14. The network device according to claim 13, wherein the L1 measurement configuration comprises a configuration of a measurement reference signal, wherein the configuration of the measurement reference signal is defined to perform the neighbor cell L1 measurement.

15. The network device according to claim 14, wherein there is one of:
the measurement reference signal comprises a synchronization signal/physical broadcast channel block (SSB), and the configuration of the measurement reference signal comprises a configuration corresponding to an SSB resource of a to-be-measured neighbor cell;
the measurement reference signal comprises a channel state information reference signal (CSI-RS), and the configuration of the measurement reference signal comprises a configuration corresponding to a CSI-RS resource of a to-be-measured neighbor cell; or
the measurement reference signal comprises an SSB and a CSI-RS, and the configuration of the measurement reference signal comprises a configuration corresponding to an SSB resource of a to-be-measured neighbor cell and a configuration corresponding to a CSI-RS resource of the to-be-measured neighbor cell.

16. The network device according to claim 15, wherein the configuration corresponding to the SSB resource of the to-be-measured neighbor cell comprises at least one of:
a cell identifier of the to-be-measured neighbor cell;
at least one SSB identifier of the to-be-measured neighbor cell; or
a configuration of a reference signal measurement window corresponding to the SSB resource of the to-be-measured neighbor cell.

17. The network device according to claim 16, wherein the configuration of the reference signal measurement window comprises at least one of:
a periodicity of occurrence of the reference signal measurement window;
an offset within a periodicity of occurrence of the reference signal measurement window;
a duration of the reference signal measurement window; or
cell identification information corresponding to a time reference cell associated with the reference signal measurement window.

18. The network device according to claim 15, wherein the configuration corresponding to the CSI-RS resource of the to-be-measured neighbor cell comprises at least one of:
a cell identifier of the to-be-measured neighbor cell;
a logical identifier corresponding to at least one CSI-RS resource of the to-be-measured neighbor cell;
a time-domain resource configuration corresponding to at least one CSI-RS resource of the to-be-measured neighbor cell;
a frequency-domain resource configuration corresponding to at least one CSI-RS resource of the to-be-measured neighbor cell; or
a quasi co-location (QCL) reference signal configuration associated with at least one CSI-RS resource of the to-be-measured neighbor cell.

19. The network device according to claim 14, wherein there is one of:
the configuration of the measurement reference signal is defined based on a physical cell identity (PCI) granularity;
the configuration of the measurement reference signal is defined based on a combined granularity of frequency point and PCI; or
the configuration of the measurement reference signal is defined based on a cell granularity.

20. The network device according to claim 13, wherein an object of the neighbor cell L1 measurement comprises at least one of:
at least one intra-frequency neighbor cell of a serving cell; or
at least one inter-frequency neighbor cell of the serving cell.
